(19) United States
(12) Patent Application Publication
(10) Pub. No.: US 2020/0096636 A1
(43) Pub. Date: Mar. 26, 2020

(54) DISTANCE MEASUREMENT SYSTEM

(71) Applicant: Sony Semiconductor Solutions Corporation, Kanagawa (JP)

(72) Inventors: Keiichi Kuroda, Tokyo (JP); Kazuhide Namba, Kanagawa (JP)

(73) Assignee: Sony Semiconductor Solutions Corporation, Kanagawa (JP)

(21) Appl. No.: 16/607,540

(22) PCT Filed: May 17, 2018
(86) PCT No.: PCT/JP2018/019105

§ 371 Date: Oct. 23, 2019

(30) Foreign Application Priority Data
May 31, 2017 (JP) 2017-108541
Jun. 29, 2017 (JP) 2017-127729

(51) Int. Cl. G01S 17/08; G01S 17/89; G01S 7/48; G01S 17/931

(52) U.S. Cl. CPC G01S 17/08; G01S 17/931; G01S 7/4808; G01S 17/89

(57) ABSTRACT

There is provided a distance measurement system for a vehicle. The system comprises a plurality of light sources including a first light source and a second light source, wherein the first light source is configured to irradiate a first irradiation range within the vehicle and the second light source is configured to irradiate a second irradiation range within the vehicle different from the first irradiation range, and at least one time-of-flight sensor arranged to sense light reflected from objects in the first irradiation range and the second irradiation range.

### TECHNICAL FIELD

The present disclosure relates to a distance measurement system and more particularly to a distance measurement system for a vehicle by which further optimization can be achieved.

### CROSS REFERENCE TO RELATED APPLICATIONS

This application claims the benefit of Japanese Priority Patent Application JP 2017-108541 filed May 31, 2017, and Japanese Priority Patent Application JP 2017-127729 filed Jun. 29, 2017, the entire contents of each of which are incorporated herein by reference.

### BACKGROUND ART

Traditionally, a time of flight (TOF) system is employed in order to measure a distance (depth) from an imaging element such as a complementary metal oxide semi-conductor (CMOS) image sensor within an imaging range to be captured by using the imaging element. In the TOF system, modulation light is radiated from a light source to a target object that is a measurement target. Then, a distance between the imaging element and the target object can be measured on the basis of the time taken until the imaging element receives reflection light that is the modulation light reflected on the target object.

For example, Patent Literature 1 has disclosed the following occupant monitoring device. In this occupant monitoring device, a desired getting-on position is irradiated with modulation light. An occupant is monitored using an image whose pixel values are only reflection light components corresponding to the modulation light in an imaging region including that irradiation region.

### CITATION LIST

### Patent Literature

PTL 1: Japanese Patent Application Laid-open No. 2010-111367

### SUMMARY OF INVENTION

### Technical Problem

By the way, it is traditionally necessary to increase the light-emitting intensity of modulation light if the distance measurement apparatus using the TOF system measures a long distance or a wide visual field. Thus, electric power supplied to the light source has to be increased. Along with this, heat generation and peak power increase. Further, if the configuration of the distance measurement apparatus designed for use at a short distance, e.g., several tens of centimeters is used for long-distance measurement without changes, errors increase in measurement apart from the imaging element. Thus, it is difficult for the distance measurement apparatus to exhibit sufficient performance, and it is desirable to achieve optimization as compared to the traditional one in terms of the heat generation, the peak power, the measurement errors, and the like. Moreover, it is desirable to provide a distance measurement system for a vehicle.

The present disclosure has been made in view of the above-mentioned circumstances to enable further optimization to be achieved.

### Solution to Problem

According to an aspect of the present disclosure, there is provided a distance measurement system for a vehicle in accordance with independent claim 1. Further aspects of the invention are set forth in the dependent claims, the drawings and the following description.

In some embodiments, the system comprises a plurality of light sources including a first light source and a second light source, wherein the first light source is configured to irradiate a first irradiation range within the vehicle and the second light source is configured to irradiate a second irradiation range within the vehicle different from the first irradiation range, and at least one time-of-flight sensor arranged to sense light reflected from objects in the first irradiation range and the second irradiation range.

Although some embodiments pertain to a distance measurement system for a vehicle, the present disclosure is not limited in that regard, and some embodiments pertain to a distance measurement system as such.

In some embodiments, the distance measurement system may include at least one distance measurement apparatus, as disclosed herein.

The (first/second) light source may include a light-emitting diode or other light sources such as a laser diode may be used.

The at least one time-of-flight sensor may include an imaging element having sensitivity to a wavelength region of light radiated from the light source. The time-of-flight sensor may include a plurality of pixels arranged in a form of an array on a sensor surface. The time-of-flight sensor may output a raw signal which includes an amount of light received by each pixel as a pixel value.

In some embodiments, the at least one time-of-flight sensor may include a first time-of-flight sensor arranged to sense light reflected from objects in the first irradiation range and a second time-of-flight sensor arranged to sense light reflected from objects in the second irradiation range.

Hence, in some embodiments, the at least one time-of-flight sensor may include two or more time-of-flight sensors.

In some embodiments, the first time-of-flight sensor may be arranged to receive light from a first imaging range that spatially overlaps the first irradiation range, and the second time-of flight sensor may be arranged to receive light from a second imaging range that spatially overlaps the second irradiation range.

Hence, the first imaging range of the first time-of-flight sensor is such arranged that at spatially overlaps the first irradiation range and the second imaging range of the second time-of-flight sensor is such arranged that it spatially overlaps the second irradiation range.

In some embodiments, each of the first time-of-flight sensor and the second time-of-flight sensor may include a sensor surface, wherein an angle of view of each of the first imaging range and the second imaging range that forms images on a respective sensor surface of the first time-of-flight sensor and the second time-of-flight sensor may be (basically) equal to each other.

Hence, the first time-of-flight sensor may have a first angle of view which results in the first imaging range and the second time-of-flight sensor may have a second angle of view which results in the second imaging range, wherein the first and the second angle of views may be (basically) equal to each other.

In some embodiments, the angle of view of each of the first imaging range and the second imaging range may be (substantially) the same.

Hence, the first angle of view may be the same as the second angle of view.

In some embodiments, the angle of view of each of the first imaging range and the second imaging range may be (approximately) 50 degrees.

Hence, the first angle of view and the second angle of view may have a value of about 50 degrees.

In some embodiments, the at least one time-of-flight sensor and the plurality of light sources may be configured to be arranged on windshield of the vehicle.

Hence, in some embodiments, the at least one time-of-flight sensor and the plurality of light source may be structurally configured such that they can be mounted to the windshield of the vehicle, or the like.

In some embodiments, the distance measurement system for a vehicle may further comprise a signal processor configured to process signals detected by the at least one time-of-flight sensor to determine a first distance to at least one object in the first irradiation range and/or the second irradiation range; and output a (at least one) control signal based, at least in part, on the first distance and/or the second distance.

In some embodiments, each of first light source and the second light source may comprise light emitting diodes (at least one light emitting diode).

In some embodiments, the at least one time-of-flight sensor may comprise a single time-of-flight sensor arranged to sense light reflected from objects in the first irradiation range and the second irradiation range. In such embodiments, the first light source may be configured to irradiate light within the first irradiation range at a first distance from the first light source, wherein the second light source may be configured to irradiate light within the second irradiation range at a second distance from the second light source, and wherein the second distance may be greater than the first distance. Furthermore, an irradiation angle of the first irradiation range and the second irradiation range may be different. Moreover, the first light source and the second light source may be configured to be arranged on a windshield of the vehicle.

In some embodiments, the first light source may be configured to irradiate light within the first irradiation range at a first distance from the first light source, the second light source may be configured to irradiate light within the second irradiation range at a second distance from the second light source, and the second distance may be (substantially) equal to the first distance. In such embodiments, as mentioned, the at least one time-of-flight sensor may comprise a single time-of-flight sensor arranged to sense light reflected from objects in the first irradiation range and the second irradiation range Moreover, an irradiation angle of the first irradiation range may be (substantially) equal to an irradiation angle of the second irradiation range.

In some embodiments, the first irradiation range and the second irradiation range may not overlap. In such embodiments, the first light source may be configured to irradiate light within the first irradiation range at a first distance from the first light source, the second light source is may be to irradiate light within the second irradiation range at a second distance from the first light source, and the second distance may be larger than the first distance. Moreover, an irradiation angle of the first irradiation range and the second irradiation range may be equal to each other (i.e. they may be substantially similar).

In some embodiments, the distance measurement system for a vehicle may further comprise a third light source and a fourth light source, wherein the third light source may be configured to irradiate a third irradiation range within the vehicle and the fourth light source may be configured to irradiate a fourth irradiation range within the vehicle, and wherein each of the first irradiation range, the second irradiation range, the third irradiation range and the fourth irradiation range may be different. Hence, the first irradiation range, the second irradiation range, the third irradiation range and the fourth irradiation range may not overlap each other and/or may only have a very small overlapping. In such embodiments, the at least one time-of-flight sensor may comprise a single sensor arranged to sense light reflected from objects in the first irradiation range, the second irradiation range, the third irradiation range, and the fourth irradiation range. Furthermore, the first light source may be configured to irradiate light within the first irradiation range at a first distance from the first light source, the second light source may be configured to irradiate light within the second irradiation range at a second distance from the second light source, the first distance and the second distance may be equal to each other (i.e. they may be substantially similar), the third light source may be configured to irradiate light within the third irradiation range at a third distance from the third light source, the fourth light source may be configured to irradiate light within the fourth irradiation range at the fourth distance from the first light source, wherein the third distance and the second distance may be equal to each other (i.e. they may be substantially similar), and the second distance may be larger than the first distance. Furthermore, the distance measurement system for a vehicle may further comprise a first wiring configured to couple the first light source to the single sensor; and a second wiring configured to couple the second light source to the single sensor. Additionally, the distance measurement system for a vehicle may further comprise a third wiring configured to couple the third light source to the single sensor, and a fourth wiring configured to couple the fourth light source to the single sensor. Alternatively, the distance measurement system for a vehicle may further comprise a third wiring configured to couple the third light source to the fourth light source.

Some embodiments pertain to a distance measurement apparatus, which may be used in embodiments of a distance measurement system as disclosed herein, and, in particular, above, including: a light source configured to radiate light to a target object that is a target whose distance is to be measured, the light being modulated; a sensor configured to receive reflection light that is light radiated from the light source and reflected on the target object; a signal processor configured to perform signal processing to determine at least a distance to the target object by using a signal output from the sensor; an error calculator configured to calculate a distance measurement error of a measurement result of measuring the distance to the target object; and a power supply configured to perform feed-back control based on the distance measurement error, convert an output voltage of a battery into a predetermined voltage, and supply the predetermined voltage.

In some embodiments, the signal processor is configured to output an application processing signal to a post-stage block and supply the application processing signal to the error calculator, the application processing signal being obtained by executing an application using the distance to the target object, and the error calculator is configured to calculate the distance measurement error on the basis of the application processing signal.

In some embodiments, the signal processor is configured to supply a depth signal to the error calculator, the depth signal indicating the distance to the target object which is determined for each pixel of the sensor, and the error calculator is configured to calculate the distance measurement error on the basis of the depth signal.

In some embodiments, the sensor is configured to supply a raw signal to the signal processor and also supply the raw signal to the error calculator, the raw signal including an amount of light received by each pixel as a pixel value, and the error calculator is configured to calculate the distance measurement error on the basis of the raw signal.

In some embodiments, the power supply is any one of a power supply for a light source which is configured to supply the light source with electric power, a power supply for a sensor which is configured to supply the sensor with electric power, and a power supply for signal processing which is configured to supply the signal processor with electric power.

Some embodiments pertain to a distance measurement method for a distance measurement apparatus, as disclosed herein, including a light source configured to radiate light to a target object that is a target whose distance is to be measured, the light being modulated, a sensor configured to receive reflection light that is light radiated from the light source and reflected on the target object, and a signal processor configured to perform signal processing to determine at least a distance to the target object by using a signal output from the sensor, the distance measurement method including: calculating a distance measurement error of a measurement result of measuring the distance to the target object; and performing feed-back control based on the distance measurement error, converting an output voltage of a battery into a predetermined voltage, and supplying the predetermined voltage.

Some embodiments pertain to a program for a distance measurement apparatus, as disclosed herein, including a light source configured to radiate light to a target object that is a target whose distance is to be measured, the light being modulated, a sensor configured to receive reflection light that is light radiated from the light source and reflected on the target object, and a signal processor configured to perform signal processing to determine at least a distance to the target object by using a signal output from the sensor, the program causing a computer to execute processing including steps of: calculating a distance measurement error of a measurement result of measuring the distance to the target object; and performing feed-back control based on the distance measurement error, converting an output voltage of a battery into a predetermined voltage, and supplying the predetermined voltage.

Some embodiments pertain to a distance measurement apparatus, which may be used in a distance measurement system as disclosed herein, including a light source configured to radiate light to a target object that is a target whose distance is to be measured, the light being modulated; a sensor configured to receive reflection light that is light radiated from the light source and reflected on the target object; and a control unit configured to control a peak voltage of the light source.

In some embodiments, the distance measurement apparatus is configured to lower a frame rate of the sensor while reducing the peak voltage of the light source.

In some embodiments, the control unit is configured to perform control to increase a voltage of electric power supplied into the sensor while reducing the peak voltage of the light source.

In some embodiments, the control unit is configured to perform control to perform pixel binning at the sensor while reducing the peak voltage of the light source.

In some embodiments, the light source includes a plurality of light sources, and the control unit is configured to reduce peak voltages of the plurality of light sources.

In some embodiments, the distance measurement apparatus is configured to form an irradiation pattern in such a manner that an amount of light increases at a portion at which irradiation light beams radiated from the plurality of light sources overlap each other.

Some embodiments pertain to a distance measurement method for a distance measurement apparatus, as disclosure herein, including a light source configured to radiate light to a target object that is a target whose distance is to be measured, the light being modulated, and a sensor configured to receive reflection light that is light radiated from the light source and reflected on the target object, the distance measurement method including controlling a peak voltage of the light source.

Some embodiments pertain to a program for a distance measurement apparatus, as disclosed herein, including a light source configured to radiate light to a target object that is a target whose distance is to be measured, the light being modulated, and a sensor configured to receive reflection light that is light radiated from the light source and reflected on the target object, the program causing a computer to execute processing including a step of controlling a peak voltage of the light source.

Some embodiments pertain to a distance measurement apparatus, which may be used in a distance measurement system as disclosed herein, including: a plurality of light sources each configured to radiate light to a target object that is a target whose distance is to be measured, the light being modulated; and one or more sensors each configured to receive reflection light that is light radiated from each of the plurality of light sources and reflected on the target object, the plurality of light sources and the one or more sensors being arranged in an inside of a space for sensing a predetermined sensing range, the space being closed.

In some embodiments, the plurality of light sources and the sensors are arranged in such a manner that each of the plurality of light sources and each of the sensors are paired and arranged in the vicinity of each other, and the predetermined sensing range in the inside of the space is divided by the paired light sources and sensors.

In some embodiments, the plurality of light sources and the one sensor are arranged in such a manner that the plurality of light sources are arranged in the vicinity of the one sensor and divide an irradiation range of the light in the inside of the space, and the one sensor receives reflection light from the divided irradiation ranges.

In some embodiments, the plurality of light sources and the one sensor are arranged in such a manner that the plurality of light sources are each arranged in the vicinity of the target object that is a measurement target thereof and divide an irradiation range of the light in the inside of the space, and the one sensor receives reflection light from the divided irradiation ranges.

In some embodiments, at least one of the plurality of light sources is arranged closer to the target object than the one sensor.

In some embodiments, the plurality of light sources are each arranged in the vicinity of the target object, which is a measurement target thereof, with respect to the one sensor, and each configured to radiate the light to the corresponding target object.

In some embodiments, the distance measurement apparatus further includes a signal processor configured to perform signal processing to determine a distance to a person who is the target object by using a signal output from the one sensor, in which the signal processor is configured to detect a particular gesture made by the person by utilizing a depth image based on the distance and output an instruction signal associated with the gesture.

In some embodiments, the distance measurement apparatus is configured to supply the plurality of light sources with electric power sequentially in a time division manner, in which the one sensor is configured to sequentially detect reflection light beams from the irradiation ranges of the plurality of light sources, the distance measurement apparatus being further configured to preferentially supply, if the signal processor detects start of a motion of the gesture made by the person in any one of the irradiation ranges, electric power to one of the plurality of light sources, which radiates the light to the one of the irradiation ranges.

In some embodiments, the one sensor is arranged in the vicinity of a rear-view mirror arranged approximately at a center of a front of an inside of a vehicle, and the plurality of light sources are each arranged to radiate the light to each of a plurality of seats installed in the vehicle, which is located in the vicinity of the light source.

In some embodiments, the one sensor and each of the plurality of light sources arranged apart from the one sensor are connected to each other through a wire and synchronized in accordance with a common synchronization signal supplied through the wire.

In some embodiments, the one sensor and each of the plurality of light sources arranged for a seat installed at the front of the inside of the vehicle are connected to each other through a wire, and the plurality of light sources arranged for a seat installed in a place other than the front of the inside of the vehicle are not connected to the one sensor but connected to each other through the wire.

### Advantageous Effects of Invention

Further according to the present disclosure, further optimization can be achieved.

It should be noted that the effects described here are not necessarily limitative and any effect described in the present disclosure may be given.

### BRIEF DESCRIPTION OF DRAWINGS

Embodiments of the invention will now be described with reference to the accompanying drawings, throughout which like parts are referred to by like references, and in which:

FIG. 1 is a block diagram showing a configuration example of a first embodiment of a distance measurement apparatus to which the present technology is applied.

FIG. 2 is a diagram showing a relationship between light-emitting power and a distance measurement error.

FIG. 3 is a flowchart describing processing of feed-back control.

FIG. 4 is a block diagram showing a configuration example of a second embodiment of the distance measurement apparatus.

FIG. 5 is a block diagram showing a configuration example of a third embodiment of the distance measurement apparatus.

FIG. 6 is a diagram describing a principle of measuring a distance.

FIG. 7 is a diagram describing a first peak power reduction method.

FIG. 8 is a diagram describing a second peak power reduction method.

FIG. 9 is a block diagram showing a configuration example of a fourth embodiment of the distance measurement apparatus.

FIG. 10 is a flowchart describing processing executed by an FPGA.

FIG. 11 is a block diagram showing a modified example of the distance measurement apparatus of FIG. 9.

FIG. 12 is a diagram describing a third peak power reduction method.

FIG. 13 is a block diagram showing a configuration example of a fifth embodiment of the distance measurement apparatus.

FIG. 14 is a block diagram showing a modified example of the distance measurement apparatus of FIG. 13.

FIG. 15 is a diagram describing a fourth peak power reduction method.

FIG. 16 is a block diagram showing a configuration example of a sixth embodiment of the distance measurement apparatus.

FIG. 17 is a block diagram showing a modified example of the distance measurement apparatus of FIG. 16.

FIG. 18 is a diagram describing an irradiation pattern.

FIG. 19 is a diagram showing a first arrangement example of light-emitting diodes and TOF sensor(s).

FIG. 20 is a diagram showing a second arrangement example of light-emitting diodes and TOF sensor(s).

FIG. 21 is a diagram showing a third arrangement example of light-emitting diodes and TOF sensor(s).

FIG. 22 is a diagram showing a relationship between a distance to a target object and a distance measurement error.

FIG. 23 is a diagram showing a fourth arrangement example of light-emitting diodes and TOF sensor(s).

FIG. 24 is a diagram showing a modified example of the fourth arrangement example.

FIG. 25 is a block diagram showing a configuration example of an embodiment of a computer to which the present technology is applied.

### DESCRIPTION OF EMBODIMENTS

Hereinafter, specific embodiments to which the present technology is applied will be described in detail with reference to the drawings.

### First Configuration Example of Distance Measurement Apparatus

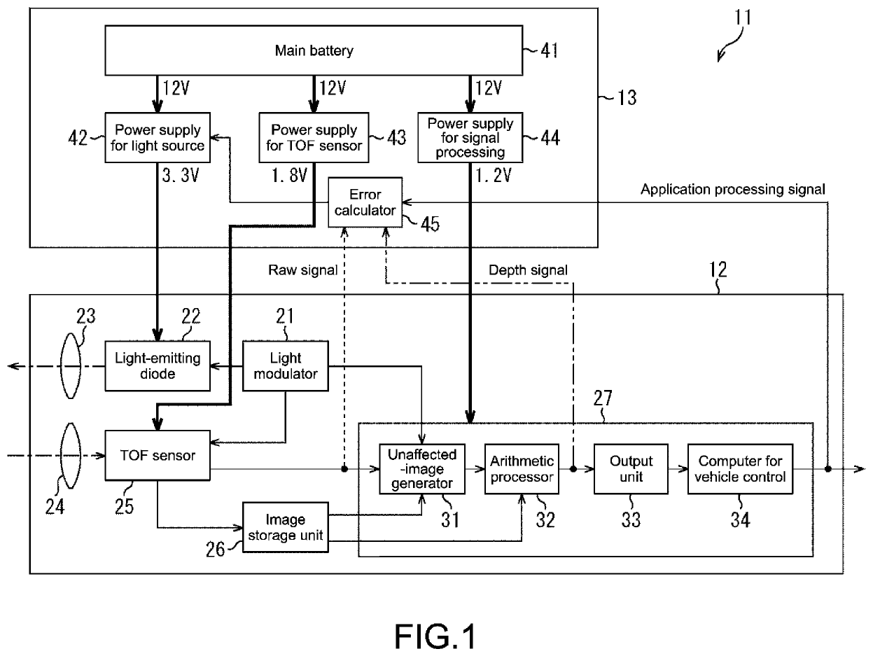

FIG. 1 is a block diagram showing a configuration example of a first embodiment of a distance measurement apparatus to which the present technology is applied.

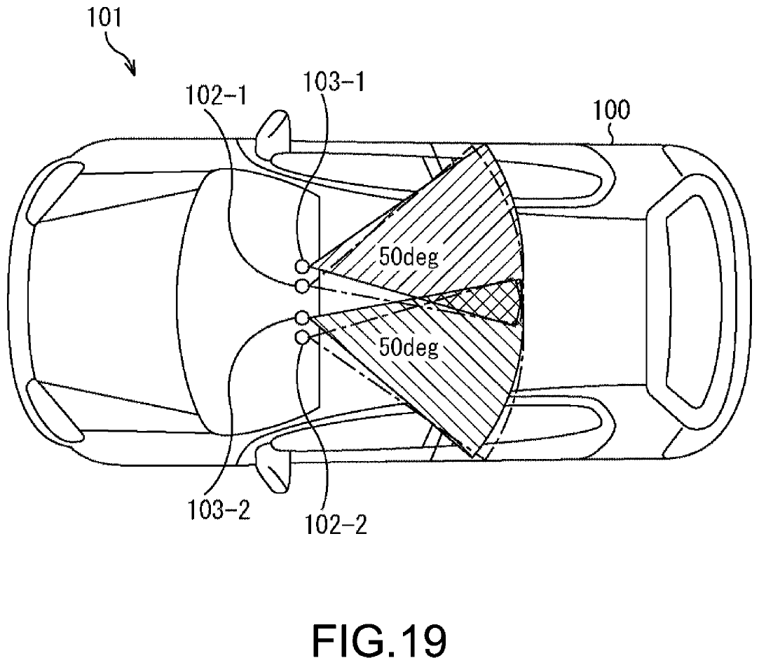

In FIG. 1, a distance measurement apparatus 11 includes a distance measurement processing unit 12 and a power supply unit 13. The distance measurement processing unit 12 is driven with electric power supplied from the power supply unit 13. For example, the distance measurement apparatus 11 is installed in a vehicle as will be described later with reference to FIGS. 19 to 24. The distance measurement apparatus 11 performs distance measurement in which an occupant of the vehicle is a target and acquires a depth image based on the measured distance. Then, the distance measurement apparatus 11 outputs an application processing signal to a post-stage block. Here, the application processing signal is obtained as a result of processing by an application using the depth image. At the post-stage block, processing is performed according to the application processing signal. For example, if an application that recognizes a gesture of the occupant by using the depth image is executed, an instruction signal associated with the gesture of the occupant is output as the application processing signal and various operations within the vehicle are controlled in accordance with the instruction based on the gesture of the occupant.

The distance measurement processing unit 12 includes a light modulator 21, a light-emitting diode 22, a light transmitter lens 23, a light receiver lens 24, a TOF sensor 25, an image storage unit 26, and a signal processor 27.

The light modulator 21 supplies a modulation signal to the light-emitting diode 22. The modulation signal is for modulating light output from the light-emitting diode 22 with a high-frequency wave of about 10 MHz, for example. Further, the light modulator 21 supplies a timing signal to the TOF sensor 25 and the signal processor 27. The timing signal indicates a timing at which light of the light-emitting diode 22 is modulated.

In accordance with the modulation signal supplied from the light modulator 21, the light-emitting diode 22 emits light while modulating light of an invisible region, for example, infrared light, at high speed. The light-emitting diode 22 radiates that light to a target object. The target object is a target whose distance is to be measured by the distance measurement apparatus 11. Note that, although the light source that radiates light to the target object is described as the light-emitting diode 22 in this embodiment, other light sources such as a laser diode may be used.

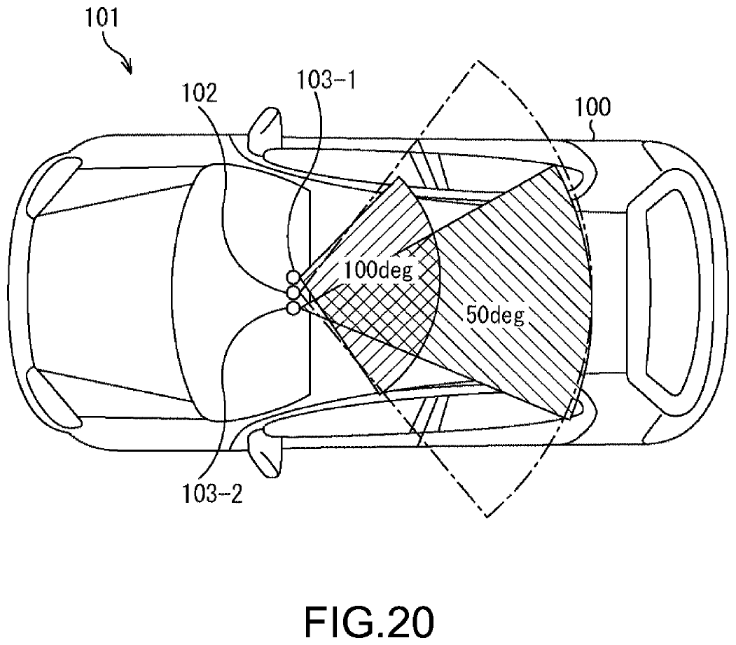

The light transmitter lens 23 includes a narrow-angle lens that adjusts distribution of light such that light radiated from the light-emitting diode 22 has a desired irradiation angle (e.g., 50 degrees or 100 degrees as shown in FIG. 20 to be described later).

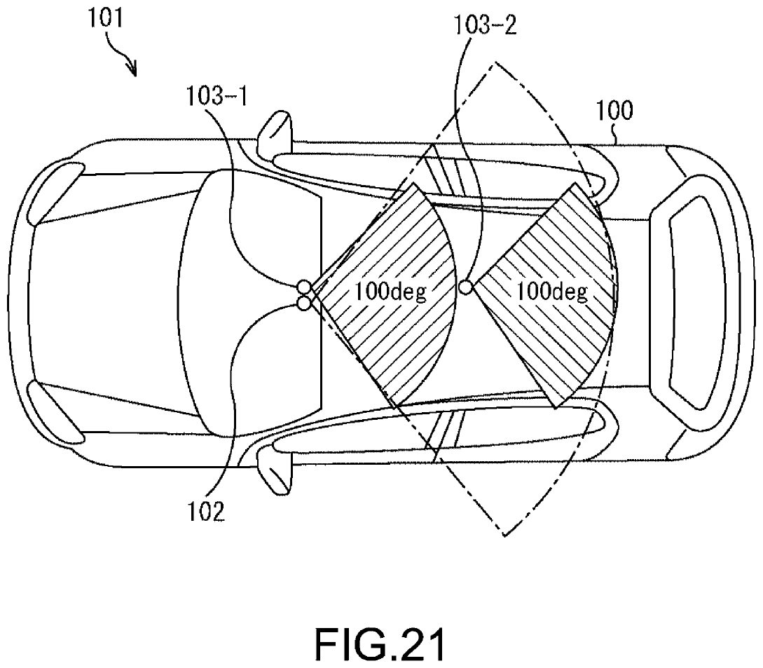

The light receiver lens 24 includes a wide-angle lens that causes an imaging range, which is captured for performing measurement of the distance by the distance measurement apparatus 11, to fall within a visual field. Then, the light receiver lens 24 forms an image of light, which is converged at an angle of view (e.g., 50 degrees as shown in FIG. 19 or 100 degrees as shown in FIG. 21 to be described later) of the imaging range, on a sensor surface of the TOF sensor 25.

The TOF sensor 25 includes an imaging element having sensitivity to a wavelength region of light radiated from the light-emitting diode 22. The TOF sensor 25 receives light whose image is formed by the light receiver lens 24, at a plurality of pixels arranged in the form of an array on the sensor surface. As shown in the figure, the TOF sensor 25 is arranged in the vicinity of the light-emitting diode 22. The TOF sensor 25 receives light from the imaging range including an irradiation range in which light is radiated by the light-emitting diode 22. Then, the TOF sensor 25 outputs a raw signal. The raw signal includes an amount of light received by each pixel as a pixel value.

The image storage unit 26 stores an image constructed by the raw signal output from the TOF sensor 25. For example, the image storage unit 26 is capable of storing a latest image when a change is made within the imaging range and storing an image in a state in which the target object is absent within the imaging range as a background image.

The signal processor 27 subjects the raw signal supplied from the TOF sensor 25 to various types of signal processing and outputs the application processing signal as described above. Further, as shown in the figure, the signal processor 27 includes an unaffected-image generator 31, an arithmetic processor 32, an output unit 33, and a computer for vehicle control 34.

In accordance with the timing signal supplied from the light modulator 21, the unaffected-image generator 31 eliminates influence of ambient light from the raw signal supplied from the TOF sensor 25. With this, the unaffected-image generator 31 generates an image (hereinafter, referred to as unaffected image) including only reflection light components corresponding to light (modulation light) radiated from the light-emitting diode 22 as pixel values. The unaffected-image generator 31 supplies the generated image to the arithmetic processor 32. Further, the unaffected-image generator 31 reads out the background image stored in the image storage unit 26. The unaffected-image generator 31 determines a difference of the background image from the image constructed by the raw signal supplied from the TOF sensor 25. In this manner, the unaffected-image generator 31 is capable of generating the unaffected image of only the target object within the imaging range.

Every time an unaffected image is supplied from the unaffected-image generator 31, the arithmetic processor 32 performs an arithmetic operation to determine a distance to the target object for each pixel of the unaffected image. The arithmetic processor 32 supplies the output unit 33 with a depth signal indicating the distance determined in that arithmetic operation. Further, in a manner that depends on needs, the arithmetic processor 32 may read out the latest image stored in the image storage unit 26 and determine the distance to the target object by using that image.

On the basis of the depth signal supplied from the arithmetic processor 32, the output unit 33 generates a depth image in which the distances to the imaged object are arranged in accordance with the arrangement of pixels. The output unit 33 outputs that depth image to the computer for vehicle control 34.

The computer for vehicle control 34 includes an electronic control unit (ECU). The ECU electronically controls respective portions of the vehicle in which the distance measurement apparatus 11 is installed, for example. The computer for vehicle control 34 executes various applications using the depth image output from the output unit 33. For example, the computer for vehicle control 34 is capable of executing an application to detect a gesture based on a hand motion of the occupant and outputting an instruction signal associated with a detected gesture, as the application processing signal. Further, the computer for vehicle control 34 is capable of executing an application to detect sleep based on a head motion of the occupant, for example, and outputting a signal indicating whether or not the occupant is sleeping, as the application processing signal.

Further, the application processing signal output from the computer for vehicle control 34 is supplied to a post-stage block that performs processing based on that application processing signal and also supplied to the power supply unit 13.

Note that the distance measurement apparatus 11 can be installed in various apparatuses other than the vehicle and can include an application executing unit that executes an application corresponding to each of the apparatuses instead of the computer for vehicle control 34.

The power supply unit 13 includes a main battery 41, a power supply for a light source 42, a power supply for a TOF sensor 43, a power supply for signal processing 44, and an error calculator 45.

The main battery 41 accumulates electric power to be mainly used for driving the distance measurement processing unit 12. The main battery 41 supplies electric power to the power supply for a light source 42, the power supply for a TOF sensor 43, and the power supply for signal processing 44. In the example shown in FIG. 1, an output voltage of the main battery 41 is set to 12 V.

The power supply for a light source 42 is a direct current/direct current (DC/DC) converter that converts the output voltage of the main battery 41 into the rating voltage of the light-emitting diode 22. The power supply for a light source 42 supplies electric power necessary for causing the light-emitting diode 22 to emit light (hereinafter, referred to as light-emitting power if necessary). In the example shown in FIG. 1, the power supply for a light source 42 converts a voltage from 12 V into 3.3 V and supplies the light-emitting power to the light-emitting diode 22. Further, as will be described later, the power supply for a light source 42 is capable of performing feed-back control according to an error signal output from the error calculator 45.

The power supply for a TOF sensor 43 is a DC/DC converter that converts the output voltage of the main battery 41 into the rating voltage of the TOF sensor 25. The power supply for a TOF sensor 43 supplies electric power necessary for driving the TOF sensor 25. In the example shown in FIG. 1, the power supply for a TOF sensor 43 converts a voltage from 12 V into 1.8 V and supplies electric power to the TOF sensor 25.

The power supply for signal processing 44 is a DC/DC converter that converts the output voltage of the main battery 41 into the rating voltage of the signal processor 27. The power supply for signal processing 44 supplies electric power necessary for driving the signal processor 27. In the example shown in FIG. 1, the power supply for signal processing 44 converts a voltage from 12 V into 1.2 V and supplies electric power to the signal processor 27.

On the basis of the application processing signal supplied from the computer for vehicle control 34, the error calculator 45 calculates a distance measurement error of a measurement result of measuring the distance to the target object. The error calculator 45 supplies an error signal indicating the distance measurement error to the power supply for a light source 42. Here, the distance measurement error refers to a fluctuation (variation) of the measurement result over time, an error caused in a single measurement value (difference from actual distance), and the like.

Thus, in the distance measurement apparatus 11, the power supply for a light source 42 is capable of performing feed-back control to adjust the light-emitting power of the light-emitting diode 22 such that the distance measurement error based on the application processing signal is maintained at a predetermined tolerance level which is permitted in post-stage processing.

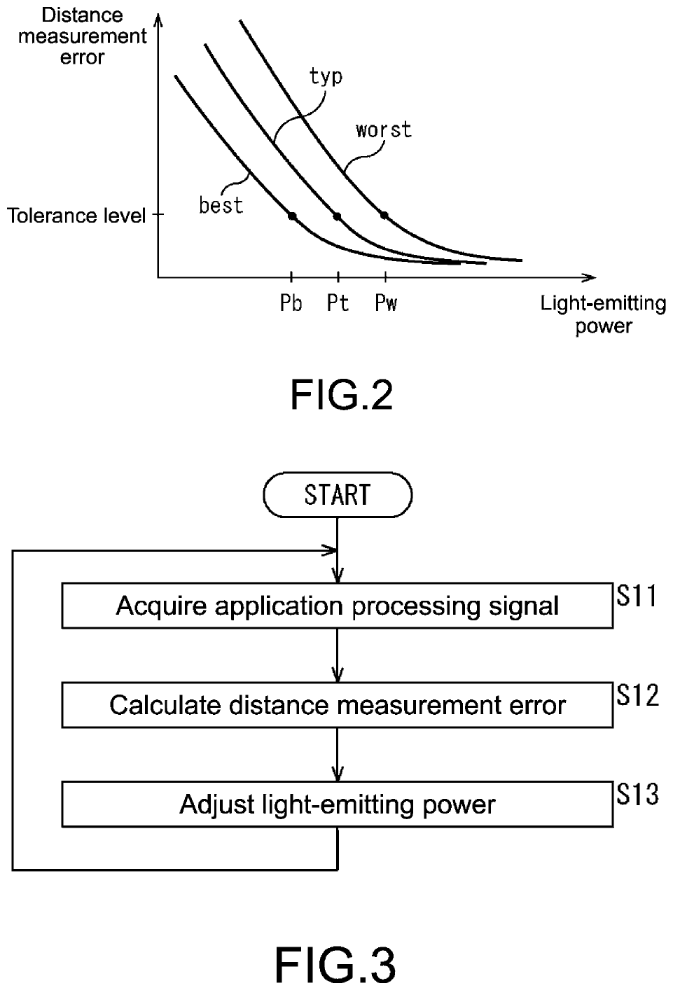

The relationship between the light-emitting power and the distance measurement error will be described with reference to FIG. 2.

In FIG. 2, the vertical axis represents the distance measurement error calculated by the error calculator 45 and the horizontal axis represents the light-emitting power supplied to the light-emitting diode 22. As expressed by curves shown in FIG. 2, there is a relationship that the distance measurement error decreases along with an increase in the light-emitting power.

Further, FIG. 2 shows a curve (typ) with a typical distance measurement error, a curve (best) with a best distance measurement error, and a curve (worst) with a worst distance measurement error in a manner that depends on individual differences of the distance measurement apparatus 11. As shown in the figure, for maintaining the distance measurement error at the tolerance level, a light-emitting power Pb in the distance measurement apparatus 11 having the best distance measurement error is lowest. Further, a light-emitting power Pt in the distance measurement apparatus 11 having the typical distance measurement error is second lowest. A light-emitting power Pw in the distance measurement apparatus 11 having the worst distance measurement error is highest.

For example, the distance measurement error of the distance measurement apparatus 11 depends on individuals. Therefore, in general, for enabling the distance measurement error to be maintained at the tolerance level even in the distance measurement apparatus 11 having the worst distance measurement error, the light-emitting power Pw is supplied to the light-emitting diode 22. That is, irrespective of whatever the distance measurement apparatus 11 is, the distance measurement error equal to or lower than the tolerance level can be realized by supplying the light-emitting power Pw to the light-emitting diode 22.

However, in the distance measurement apparatus 11 having the typical distance measurement error or the distance measurement apparatus 11 having the best distance measurement error, supplying the light-emitting power Pw to the light-emitting diode 22 leads to unnecessary power consumption. In view of this, feed-back control is performed such that a suitable amount of light-emitting power is supplied to the light-emitting diode 22 in a manner that depends on the distance measurement error of the distance measurement apparatus 11. In this manner, power consumption can be reduced.

Thus, as described above, the power supply for a light source 42 of the distance measurement apparatus 11 adjusts a voltage supplied to the light-emitting diode 22 to lower the light-emitting power of the light-emitting diode 22 such that the distance measurement error based on the application processing signal is maintained at the tolerance level. With this, optimization of electric power supplied to the light-emitting diode 22 can be achieved in a manner that depends on the individual differences of the distance measurement apparatus 11, and power consumption can be reduced in comparison with the traditional case.

As a result, the distance measurement apparatus 11 is capable of reducing heat generation and downsizing a cooling mechanism, for example. Thus, the distance measurement apparatus 11 is capable of achieving downsizing of the entire apparatus. Further, consumption of electric power accumulated in the main battery 41 is reduced. Therefore, the distance measurement apparatus 11 is capable of prolonging the driving time with the main battery 41.

Note that, as described above, the distance measurement apparatus 11 is not limited to the configuration in which the computer for vehicle control 34 supplies the error calculator 45 with the application processing signal and feed-back based on the application processing signal is performed.

For example, the distance measurement apparatus 11 can be configured in such a manner that, as shown by the broken-line arrow of FIG. 1, the raw signal output from the TOF sensor 25 is supplied to the error calculator 45. In the thus configured distance measurement apparatus 11, the error calculator 45 calculates the distance measurement error based on the raw signal. Then, the error calculator 45 supplies the error signal indicating the calculated distance measurement error to the power supply for a light source 42. In this manner, the feed-back control as described above is performed. That is, the power supply for a light source 42 is capable of adjusting the voltage of the light-emitting power supplied to the light-emitting diode 22 such that the distance measurement error based on the raw signal is maintained at the tolerance level.

Similarly, the distance measurement apparatus 11 can be configured in such a manner that, as shown by the arrow of the long dashed double-short dashed line of FIG. 1, the depth signal output from the arithmetic processor 32 is supplied to the error calculator 45. In the thus configured distance measurement apparatus 11, the error calculator 45 calculates the distance measurement error based on the depth signal. Then, the error calculator 45 supplies the error signal indicating the calculated distance measurement error to the power supply for a light source 42. The feed-back control as described above is performed in this manner. That is, the power supply for a light source 42 is capable of adjusting the voltage of the light-emitting power supplied to the light-emitting diode 22 such that the distance measurement error based on the depth signal is maintained at the tolerance level.

Next, FIG. 3 is a flowchart describing processing of feed-back control executed in the distance measurement apparatus 11.

For example, the distance measurement apparatus 11 is activated. The distance measurement processing unit 12 outputs an application processing signal. Then, the processing is started. In Step S11, the error calculator 45 acquires the application processing signal output from the distance measurement processing unit 12.

In Step S12, on the basis of the application processing signal acquired in Step S11, the error calculator 45 calculates a distance measurement error of a measurement result of measuring the distance to the target object and supplies the distance measurement error to the power supply for a light source 42.

In Step S13, the power supply for a light source 42 performs feed-back control to adjust the voltage of the light-emitting power supplied to the light-emitting diode 22 to lower the light-emitting power of the light-emitting diode 22 such that the distance measurement error supplied in Step S12 is maintained at the tolerance level.

After that, the processing returns to Step S11. Then, similar processing is repeatedly performed.

As described above, the distance measurement apparatus 11 performs feed-back control to adjust the voltage of the light-emitting power supplied to the light-emitting diode 22. In this manner, power consumption can be reduced.

### Second Configuration Example of Distance Measurement Apparatus

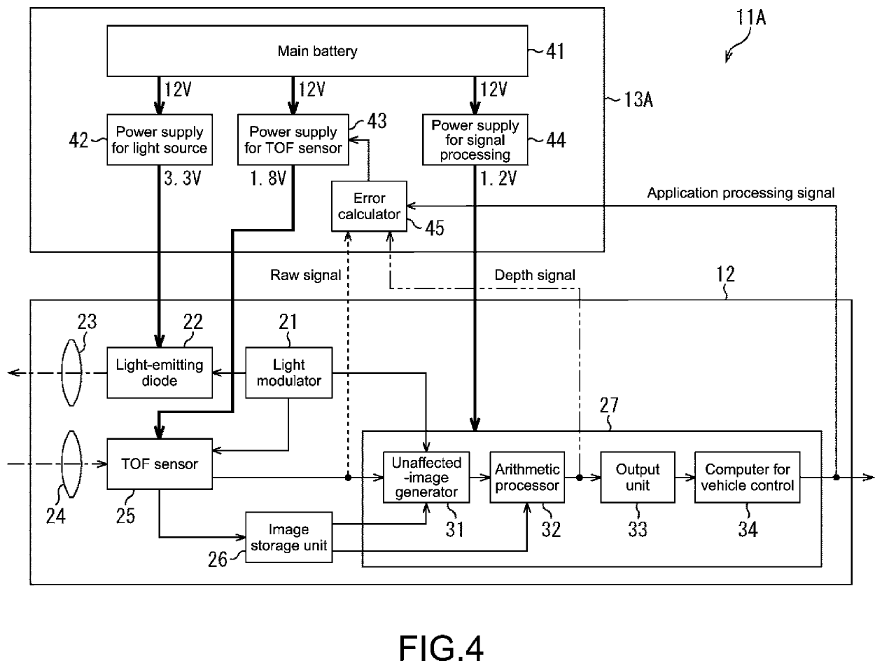

FIG. 4 is a block diagram showing a configuration example of a second embodiment of the distance measurement apparatus to which the present technology is applied. Note that, in a distance measurement apparatus 11A shown in FIG. 4, configurations common to the distance measurement apparatus 11 of FIG. 1 will be denoted by identical signs and detailed descriptions thereof will be omitted.

As shown in FIG. 4, the distance measurement apparatus 11A includes the distance measurement processing unit 12 and a power supply unit 13A. Then, the distance measurement apparatus 11A has a configuration different from that of the distance measurement apparatus 11 of FIG. 1 in that the error calculator 45 is configured to output the error signal to the power supply for a TOF sensor 43 in the power supply unit 13A.

That is, in the distance measurement apparatus 11A, the power supply for a TOF sensor 43 is configured to perform feed-back control according to the error signal output from the error calculator 45. For example, the power supply for a TOF sensor 43 is capable of adjusting the voltage of electric power supplied to the TOF sensor 25 such that the distance measurement error is maintained at the tolerance level.

With this, as in the distance measurement apparatus 11 of FIG. 1, the distance measurement apparatus 11A is capable of reducing power consumption and achieving optimization as a whole.

Note that, in the distance measurement apparatus 11A, as shown by the broken-line arrow of FIG. 4, the configuration in which the raw signal output from the TOF sensor 25 is supplied to the error calculator 45 can be employed and the feed-back control according to the error signal based on the raw signal can be performed. Similarly, in the distance measurement apparatus 11A, as shown by the arrow of the long dashed double-short dashed line of FIG. 4, the configuration in which the depth signal output from the arithmetic processor 32 is supplied to the error calculator 45 can be employed and the feed-back control according to the error signal based on the depth signal can be performed.

### Third Configuration Example of Distance Measurement Apparatus

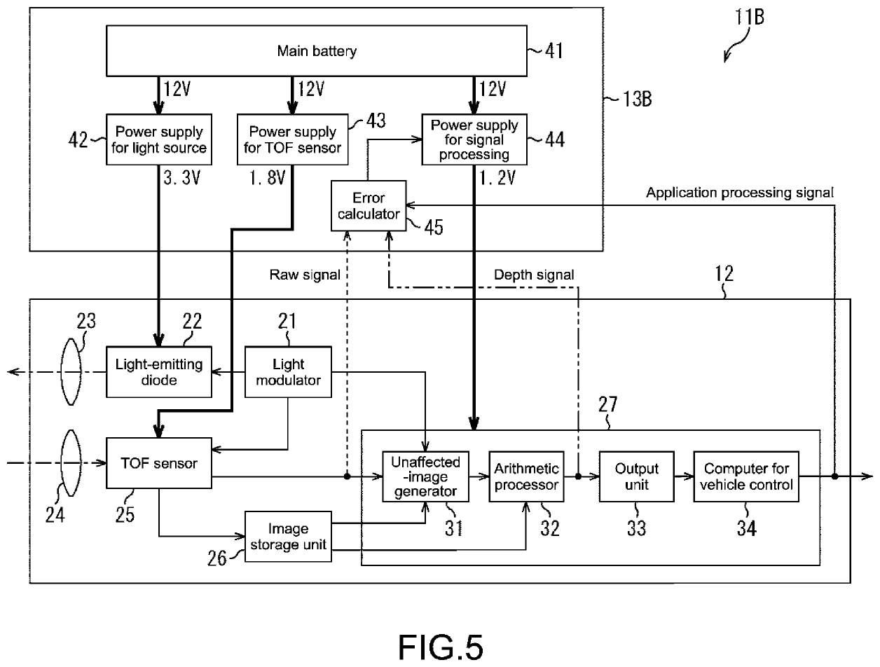

FIG. 5 is a block diagram showing a configuration example of a third embodiment of the distance measurement apparatus to which the present technology is applied. Note that, in a distance measurement apparatus 11B shown in FIG. 5, configurations common to the distance measurement apparatus 11 of FIG. 1 will be denoted by identical signs and detailed descriptions thereof will be omitted.

As shown in FIG. 5, the distance measurement apparatus 11B includes the distance measurement processing unit 12 and a power supply unit 13B. Then, the distance measurement apparatus 11B has a configuration different from that of the distance measurement apparatus 11 of FIG. 1 in that, in the power supply unit 13B, the error calculator 45 is configured to output the error signal to the power supply for signal processing 44.

That is, in the distance measurement apparatus 11B, the power supply for signal processing 44 is configured to perform feed-back control according to the error signal output from the error calculator 45. For example, the power supply for signal processing 44 is capable of adjusting the voltage of electric power supplied to the signal processor 27 such that the distance measurement error is maintained at the tolerance level.

With this, the distance measurement apparatus 11B is capable of reducing power consumption and achieving optimization as a whole as in the distance measurement apparatus 11 of FIG. 1.

Note that, in the distance measurement apparatus 11B, as shown by the broken-line arrow of FIG. 5, the configuration in which the raw signal output from the TOF sensor 25 is supplied to the error calculator 45 can be employed and the feed-back control according to the error signal based on the raw signal can be performed. Similarly, in the distance measurement apparatus 11B, as shown by the arrow of the long dashed double-short dashed line of FIG. 5, the configuration in which the depth signal output from the arithmetic processor 32 is supplied to the error calculator 45 and the feed-back control according to the error signal based on the depth signal can be performed.

As described above, the distance measurement apparatuses 11 to 11B are capable of reducing heat generation because consumed average electric power can be lowered, and is capable of achieving downsizing as the entire apparatus, for example.

<Reduction in Peak Power>

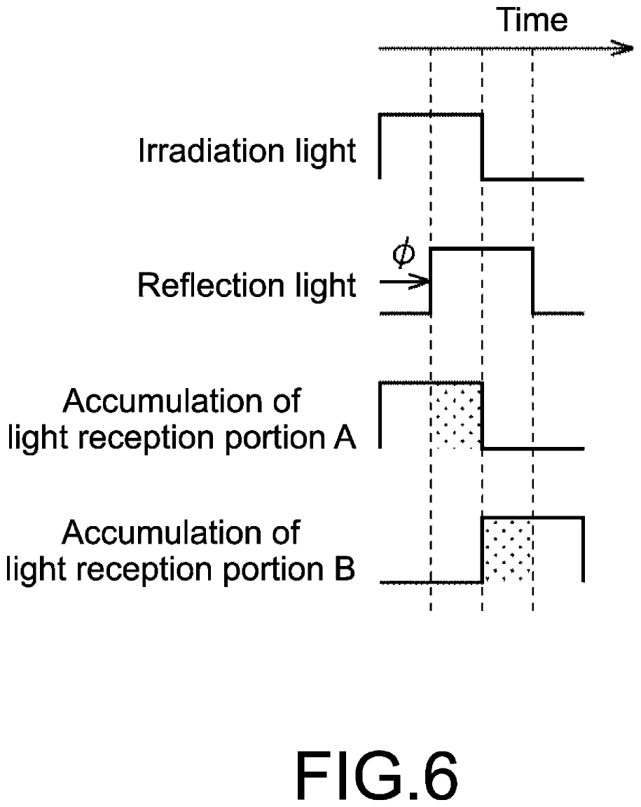

A reduction in peak power in the distance measurement apparatus 11 will be described with reference to FIGS. 6 to 19.

First of all, a principle of measuring a distance in the distance measurement apparatus 11 will be described with reference to FIG. 6.

For example, irradiation light is radiated from the light-emitting diode 22 to the target object. Reflection light that is the irradiation light reflected on the target object is received by the TOF sensor 25 while being delayed by a time Φ from a timing at which irradiation light is radiated in a manner that depends on a distance to the target object. At this time, at the TOF sensor 25, the reflection light is received by a light reception portion A and a light reception portion B and charges are accumulated by each of the light reception portion A and the light reception portion B. The light reception portion A receives light for a time interval when the light-emitting diode 22 is radiating irradiation light. The light reception portion B receives light for the same time interval after the light reception of the light reception portion A ends.

Thus, a time Φ until the reflection light is received can be determined on the basis of a ratio of the charges accumulated by the light reception portion A and the charges accumulated by the light reception portion B. The distance to the target object can be calculated on the basis of light speed.

As can be seen, at the distance measurement apparatus 11, electric power consumed by the light-emitting diode 22 peaks while the light-emitting diode 22 is radiating irradiation light. Then, when the peak power is reduced in order to reduce the power consumption of the distance measurement apparatus 11, reflection light received at the TOF sensor 25 weakens. Therefore, the sensor sensitivity of the TOF sensor 25 lowers. Therefore, it is necessary to reduce the peak power while avoiding lowering of the sensor sensitivity of the TOF sensor 25.

<First Peak Power Reduction Method>

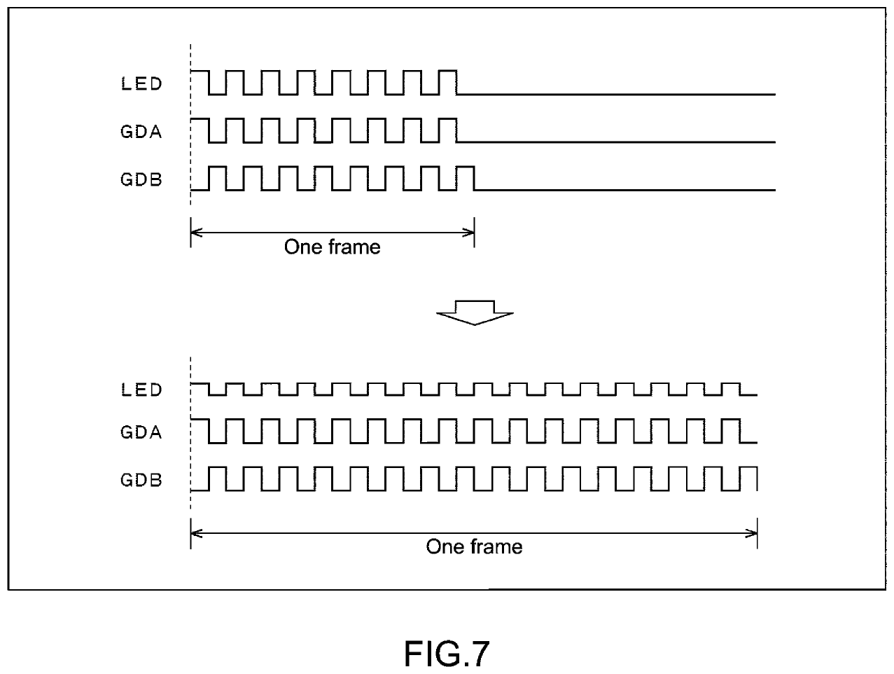

A first peak power reduction method will be described with reference to FIG. 7.

FIG. 7 shows an electric power LED, an electric power GDA, and an electric power GDB. The electric power LED is consumed by the light-emitting diode 22 to radiate irradiation light. The electric power GDA is consumed for driving the light reception portion A of the TOF sensor 25. The electric power GDB is consumed for driving the light reception portion B of the TOF sensor 25.

For example, in the first peak power reduction method, a time necessary for generating one frame of the depth image is extended while reducing the peak power of the electric power LED. As a result, the frame rate lowers. With this, charges accumulated in the light reception portion A of the TOF sensor 25 and the light reception portion B per time of one frame becomes similar to the traditional one. Thus, lowering of the sensor sensitivity of the TOF sensor 25 can be avoided.

In this manner, the distance measurement apparatus 11 is capable of reducing the peak power without lowering the sensor sensitivity of the TOF sensor 25 and is capable of achieving downsizing as the entire apparatus, for example.

### Fourth Configuration Example of Distance Measurement Apparatus

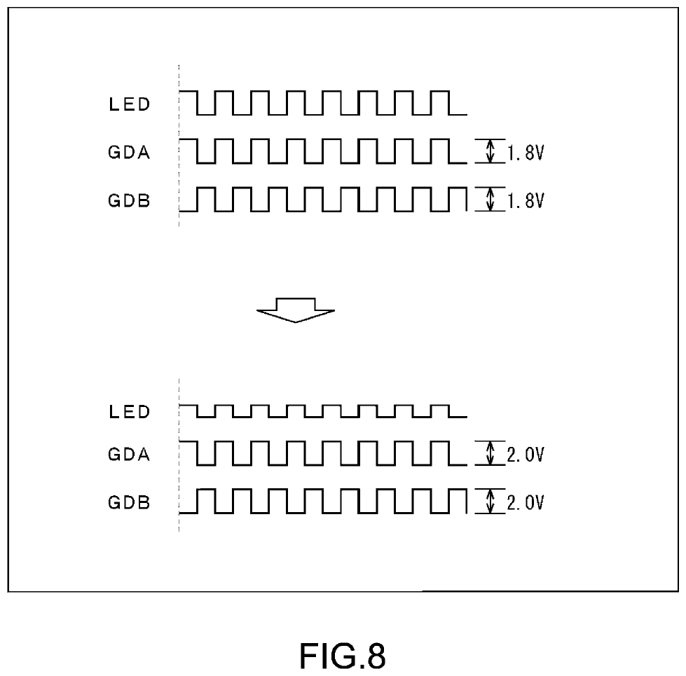

First of all, a second peak power reduction method will be described with reference to FIG. 8.

FIG. 8 shows an electric power LED, an electric power GDA, and an electric power GDB. The electric power LED is consumed by the light-emitting diode 22 to radiate irradiation light. The electric power GDA is consumed for driving the light reception portion A of the TOF sensor 25. The electric power GDB is consumed for driving the light reception portion B of the TOF sensor 25.

For example, in the second peak power reduction method, a supply voltage supplied to the TOF sensor 25 is increased while reducing the peak power of the electric power LED. By increasing the supply voltage for the TOF sensor 25 in this manner, it is possible to increase accumulated charges corresponding to reception of reflection light by the light reception portion A of the TOF sensor 25 and the light reception portion B and to avoid lowering of the sensor sensitivity of the TOF sensor 25.

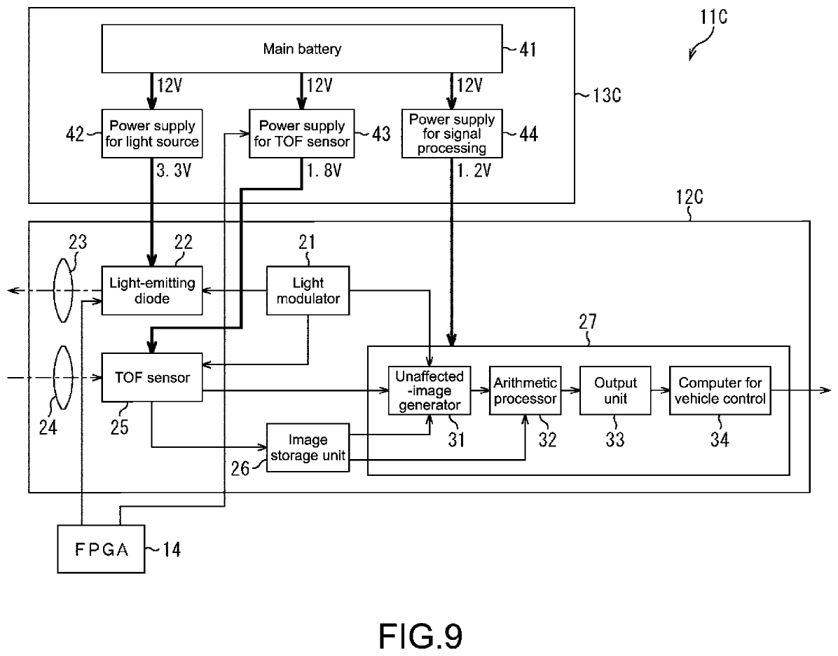

FIG. 9 is a block diagram showing a configuration example of a fourth embodiment of the distance measurement apparatus to which the present technology is applied. Note that, in a distance measurement apparatus 11C shown in FIG. 9, configurations common to the distance measurement apparatus 11 of FIG. 1 will be denoted by identical signs and detailed descriptions thereof will be omitted.

As shown in FIG. 9, the distance measurement apparatus 11C includes a distance measurement processing unit 12C, a power supply unit 13C, and a field programmable gate array (FPGA) 14. The distance measurement apparatus 11C has a configuration different from that of the distance measurement apparatus 11 of FIG. 1 in that the distance measurement processing unit 12C is configured not to supply the application processing signal, the raw signal, and the depth signal to the power supply unit 13C and the power supply unit 13C does not include the error calculator 45.

The FPGA 14 is an integrated circuit whose configuration can be set by a designer. The FPGA 14 can be, for example, programmed to control the light-emitting diode 22 and the power supply for a TOF sensor 43. That is, in the distance measurement processing unit 12C, the FPGA 14 is capable of controlling the light-emitting diode 22 to reduce the peak power consumed for radiating irradiation light and controlling the power supply for a TOF sensor 43 to increase the supply voltage for the TOF sensor 25.

Thus, as described with reference to FIG. 8, the distance measurement processing unit 12C is capable of reducing the peak power without lowering the sensor sensitivity of the TOF sensor 25.

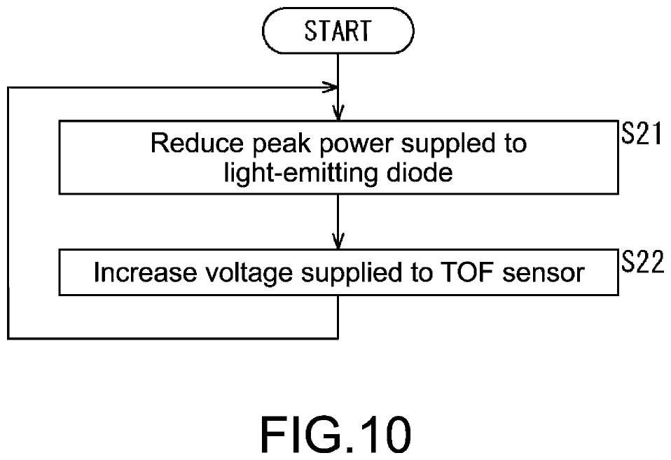

Next, FIG. 10 is a flowchart describing processing executed by the FPGA 14 of FIG. 9.

For example, the distance measurement apparatus 11C is activated. Then, the processing is started. In Step S21, the FPGA 14 controls the light-emitting diode 22 to reduce the peak power.

In Step S22, the FPGA 14 controls the power supply for a TOF sensor 43 to increase the supply voltage for the TOF sensor 25 and the processing is terminated.

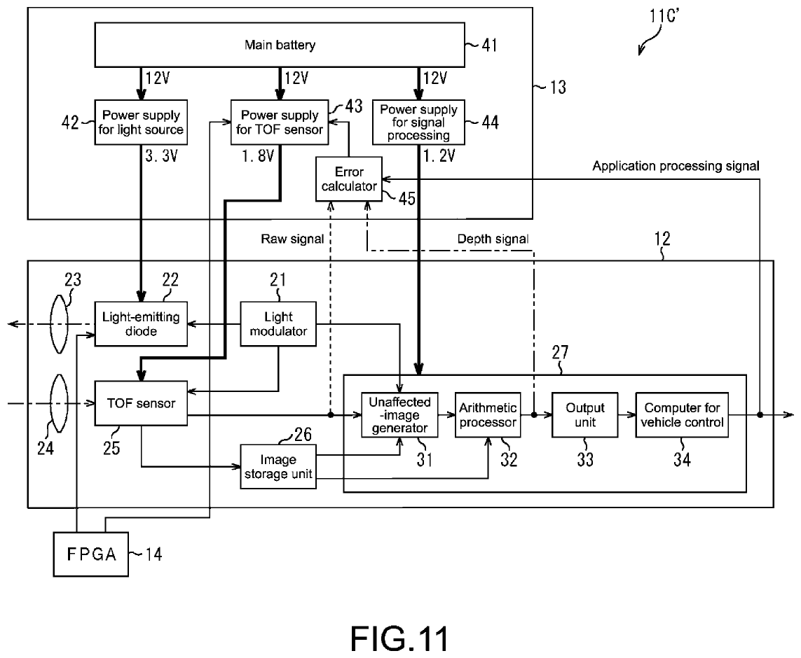

A modified example of the distance measurement apparatus 11C of FIG. 9 will be described with reference to FIG. 11. Note that, in a distance measurement apparatus 11C′ shown in FIG. 11, the distance measurement apparatus 11C of FIG. 9 and configurations common to the distance measurement apparatus 11 of FIG. 1 will be denoted by identical signs and detailed descriptions thereof will be omitted.

As shown in FIG. 11, the distance measurement apparatus 11C′ has a configuration combining the distance measurement apparatus 11C of FIG. 9 with the distance measurement apparatus 11 of FIG. 1. That is, the distance measurement apparatus 11C′ includes an FPGA 14 similar to that of the distance measurement apparatus 11C of FIG. 9 as well as a distance measurement processing unit 12 and a power supply unit 13 which are configured similar to those of the distance measurement apparatus 11 of FIG. 1.

Thus, as in the distance measurement apparatus 11C of FIG. 9, the distance measurement apparatus 11C′ is capable of reducing the peak power and capable of performing feed-back control to reduce power consumption in accordance with the error signal as in the distance measurement apparatus 11 of FIG. 1. With this, the distance measurement apparatus 11C′ is capable of achieving optimization of the electric power in comparison with the traditional one. Thus, the distance measurement apparatus 11C′ is capable of prolonging the driving time with the main battery 41 and capable of achieving downsizing of the entire apparatus. As a result, a more optimal configuration as a whole can be realized.

### Fifth Configuration Example of Distance Measurement Apparatus

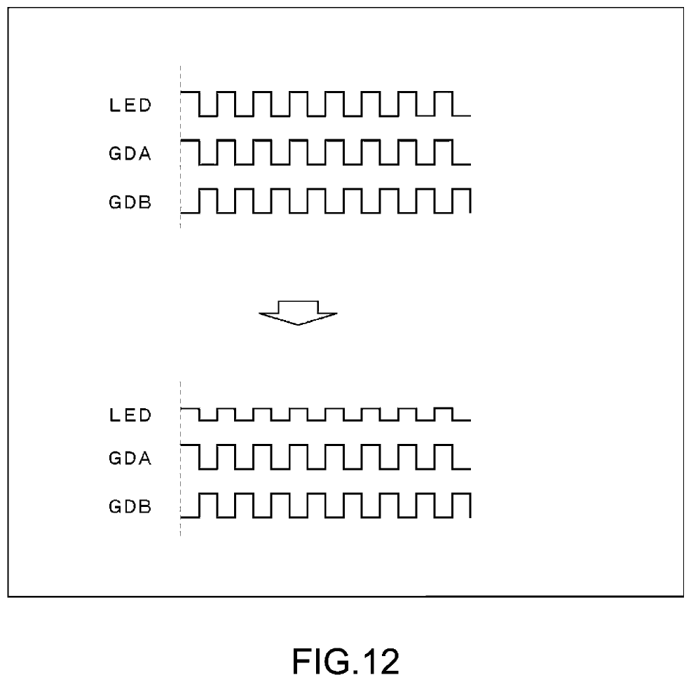

First of all, a third peak power reduction method will be described with reference to FIG. 12.

In FIG. 12, the electric power LED is consumed by the light-emitting diode 22 to radiate irradiation light. The electric power GDA is consumed for driving the light reception portion A of the TOF sensor 25. The electric power GDB is consumed for driving the light reception portion B of the TOF sensor 25.

For example, in the third peak power reduction method, pixel binning is performed at the TOF sensor 25 while reducing the peak power of the electric power LED. The pixel binning refers to adding pixel values at a plurality of pixels. By adding the pixel values at the plurality of pixels in this manner, charges after the pixel binning can be similar to the traditional one and lowering of the sensor sensitivity of the TOF sensor 25 can be avoided.

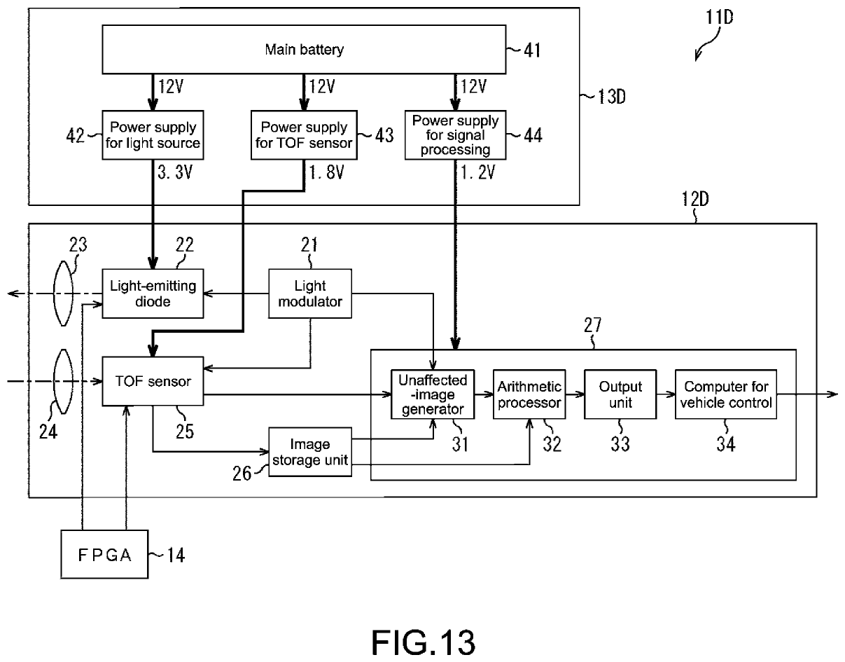

FIG. 13 is a block diagram showing a configuration example of a fifth embodiment of the distance measurement apparatus to which the present technology is applied. Note that, in a distance measurement apparatus 11D shown in FIG. 13, configurations common to the distance measurement apparatus 11 of FIG. 1 and the distance measurement apparatus 11C of FIG. 9 will be denoted by identical signs and detailed descriptions thereof will be omitted.

As shown in FIG. 13, the distance measurement apparatus 11D includes a distance measurement processing unit 12D, a power supply unit 13D, and the FPGA 14. The distance measurement apparatus 11D has a configuration different from that of the distance measurement apparatus 11 of FIG. 1 in that the distance measurement processing unit 12D is configured not to supply the application processing signal, the raw signal, and the depth signal to the power supply unit 13D and the power supply unit 13D does not include the error calculator 45.

Further, in the distance measurement apparatus 11D, the FPGA 14 is programmed to control the light-emitting diode 22 and the TOF sensor 25. That is, in the distance measurement processing unit 12D, the FPGA 14 is capable of controlling the light-emitting diode 22 to reduce the peak power consumed for radiating irradiation light and capable of controlling the TOF sensor 25 to perform pixel binning.

Thus, the distance measurement processing unit 12D is capable of reducing the peak power without lowering the sensor sensitivity of the TOF sensor 25.

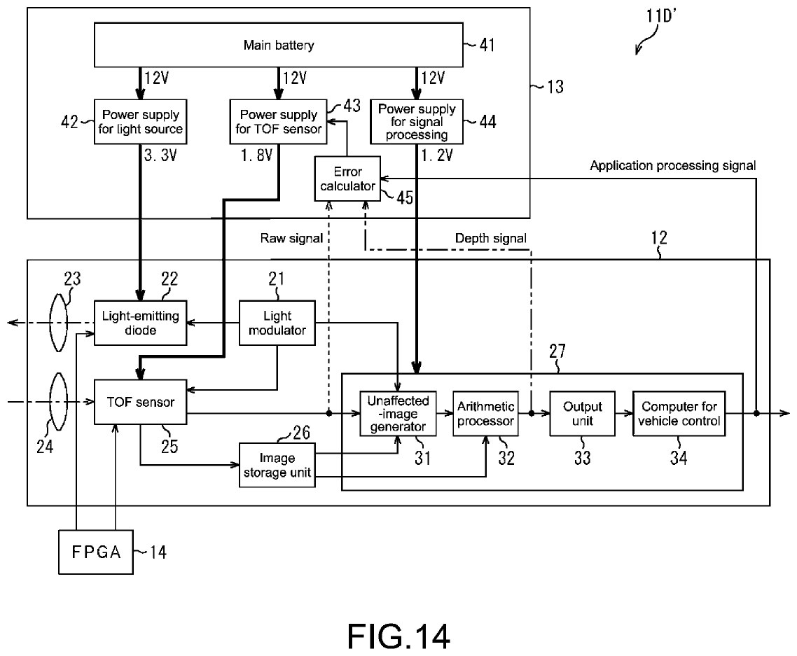

A modified example of the distance measurement apparatus 11D of FIG. 13 will be described with reference to FIG. 14. Note that, in a distance measurement apparatus 11D′ shown in FIG. 11, the distance measurement apparatus 11D of FIG. 13 and configurations common to the distance measurement apparatus 11 of FIG. 1 will be denoted by identical signs and detailed descriptions thereof will be omitted.

As shown in FIG. 14, the distance measurement apparatus 11D′ has a configuration combining the distance measurement apparatus 11D of FIG. 13 with the distance measurement apparatus 11 of FIG. 1. That is, the distance measurement apparatus 11D′ includes an FPGA 14 similar to that of the distance measurement apparatus 11D of FIG. 13 as well as a distance measurement processing unit 12 and a power supply unit 13 which are configured similar to those of the distance measurement apparatus 11 of FIG. 1.

Thus, the distance measurement apparatus 11D′ is capable of reducing the peak power as in the distance measurement apparatus 11D of FIG. 13 and capable of performing feed-back control to reduce power consumption in accordance with the error signal as in the distance measurement apparatus 11 of FIG. 1. With this, the distance measurement apparatus 11D′ is capable of achieving optimization of the electric power in comparison with the traditional one. Thus, the distance measurement apparatus 11D′ is capable of prolonging the driving time with the main battery 41 and capable of achieving downsizing of the entire apparatus. As a result, a more optimal configuration as a whole can be realized.

### Sixth Configuration Example of Distance Measurement Apparatus

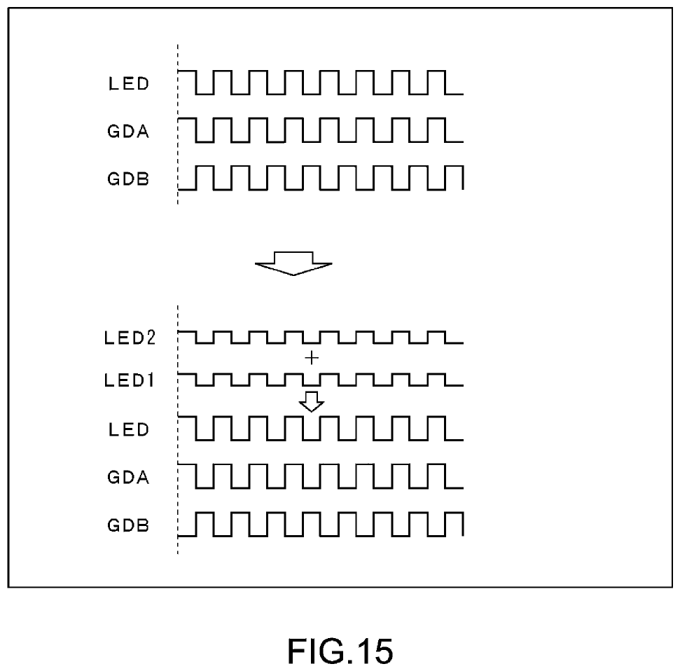

First of all, a fourth peak power reduction method will be described with reference to FIG. 15.

FIG. 15 shows an electric power LED, an electric power GDA, and an electric power GDB. The electric power LED is consumed by the light-emitting diode 22 to radiate irradiation light. The electric power GDA is consumed for driving the light reception portion A of the TOF sensor 25. The electric power GDB is consumed for driving the light reception portion B of the TOF sensor 25.

For example, in the fourth peak power reduction method, a plurality of light-emitting diodes 22 are used and the peak power of each light-emitting diode 22 is reduced. Specifically, by using two light-emitting diodes 22 each of which has a peak power reduced by half, the intensity of irradiation light radiated from those light-emitting diodes 22 can be similar to the traditional one and lowering of the sensor sensitivity of the TOF sensor 25 can be avoided.

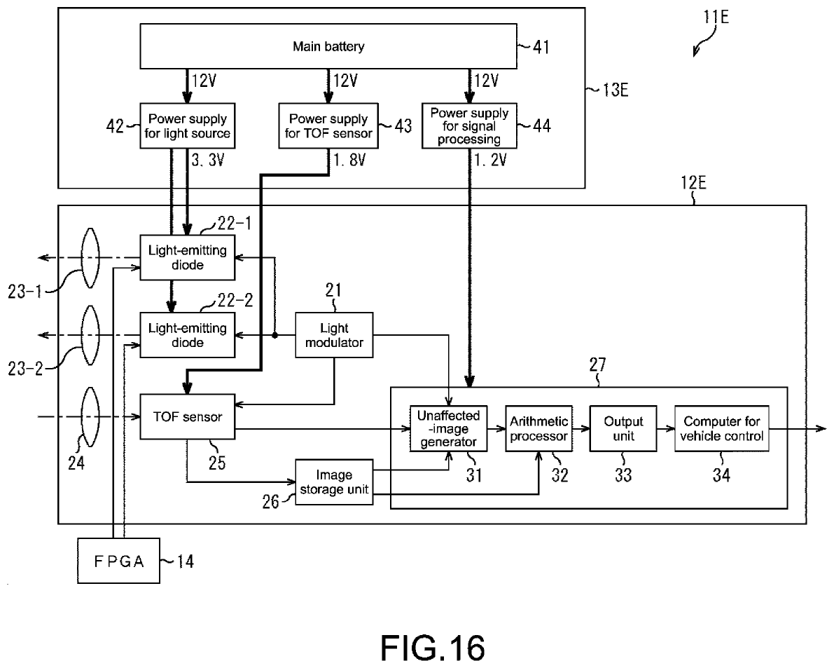

FIG. 16 is a block diagram showing a configuration example of a sixth embodiment of the distance measurement apparatus to which the present technology is applied. Note that, in a distance measurement apparatus 11E shown in FIG. 16, configurations common to the distance measurement apparatus 11 of FIG. 1 will be denoted by identical signs and detailed descriptions thereof will be omitted.

As shown in FIG. 16, the distance measurement apparatus 11E includes a distance measurement processing unit 12E, a power supply unit 13E, and the FPGA 14. The distance measurement apparatus 11E has a configuration different from that of the distance measurement apparatus 11 of FIG. 1 in that the distance measurement processing unit 12E is configured not to supply the application processing signal, the raw signal, and the depth signal to the power supply unit 13E and the power supply unit 13E does not include the error calculator 45.

Then, in the distance measurement apparatus 11E, the distance measurement processing unit 12E includes two light-emitting diodes 22-1 and 22-2 and two light transmitter lenses 23-1 and 23-2. Further, in the distance measurement apparatus 11E, the FPGA 14 is programmed to control the light-emitting diodes 22-1 and 22-2. That is, in the distance measurement processing unit 12E, the FPGA 14 is capable of controlling the light-emitting diodes 22-1 and 22-2 to reduce the peak power consumed for radiating irradiation light. With this, an amount of light at a position at which irradiation light beams of the light-emitting diodes 22-1 and 22-2 overlap each other can be similar to the traditional one and lowering of the sensor sensitivity of the TOF sensor 25 can be avoided.

Thus, the distance measurement processing unit 12E is capable of reducing the peak power without lowering the sensor sensitivity of the TOF sensor 25.

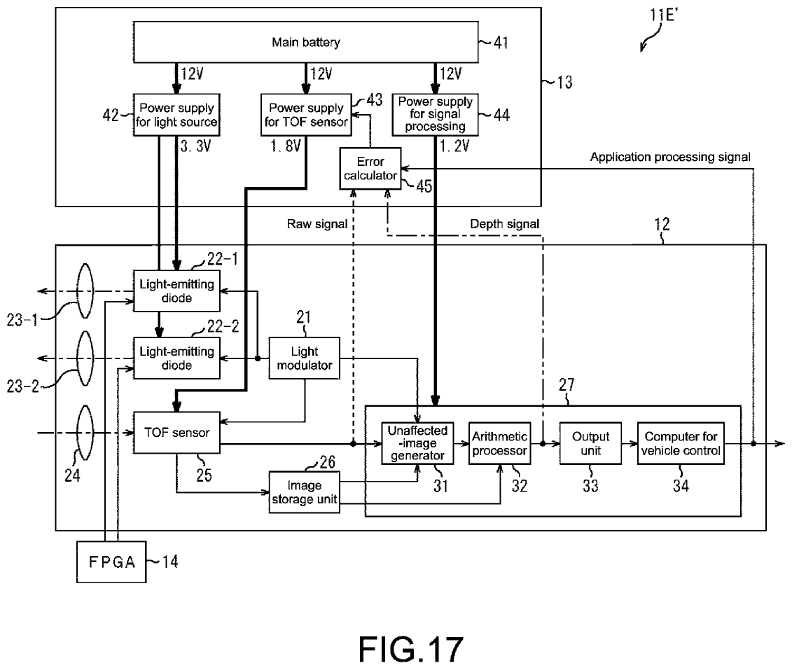

A modified example of the distance measurement apparatus 11E of FIG. 16 will be described with reference to FIG. 17. Note that, in the distance measurement apparatus 11E′ shown in FIG. 17, the distance measurement apparatus 11E of FIG. 16 and configurations common to the distance measurement apparatus 11 of FIG. 1 will be denoted by identical signs and detailed descriptions thereof will be omitted.

As shown in FIG. 17, the distance measurement apparatus 11E′ has a configuration combining the distance measurement apparatus 11E of FIG. 16 with the distance measurement apparatus 11 of FIG. 1. That is, the distance measurement apparatus 11E′ includes an FPGA 14 similar to that of the distance measurement apparatus 11E of FIG. 16 as well as a distance measurement processing unit 12 and a power supply unit 13 which are configured similar to those of the distance measurement apparatus 11 of FIG. 1.

Thus, the distance measurement apparatus 11E′ is capable of reducing the peak power as in the distance measurement apparatus 11E of FIG. 16 and capable of reducing average electric power as in the distance measurement apparatus 11 of FIG. 1. Thus, optimization of electric power can be achieved in comparison with the traditional one. Thus, the distance measurement apparatus 11E′ is capable of prolonging the driving time with the main battery 41 and capable of achieving downsizing of the entire apparatus. As a result, a more optimal configuration as a whole can be realized.

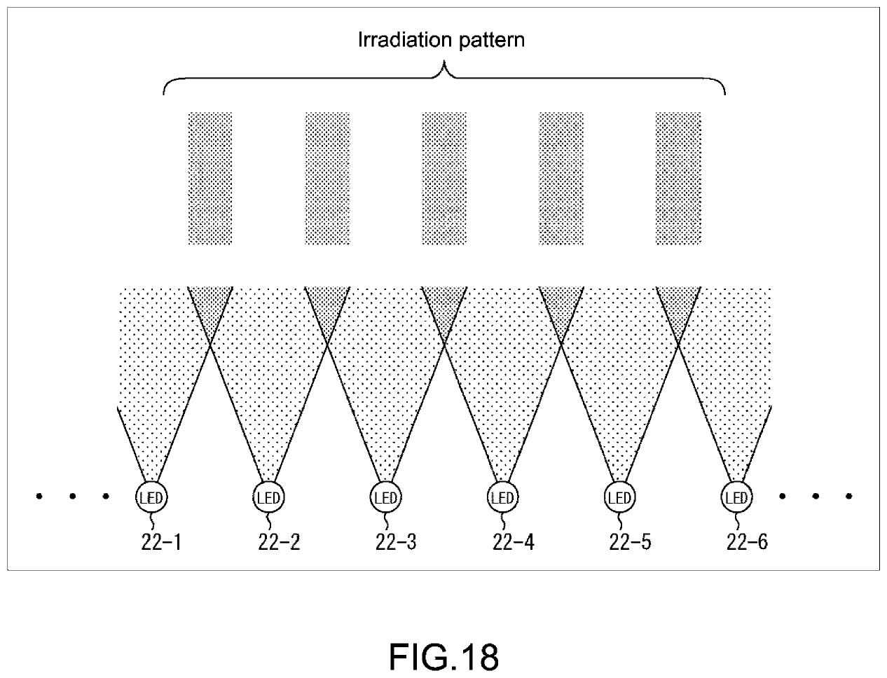

Note that the number of light-emitting diodes 22 of the distance measurement apparatus 11 is not limited to two as in the distance measurement apparatus 11E of FIG. 16, a configuration including two or more light-emitting diodes 22 may be employed. In this case, for example, as shown in FIG. 18, it is possible to achieve an improvement in the distance measurement accuracy with structured light by utilizing the ununiformity of the irradiation pattern that the amount of light increases at the portion at which irradiation light beams radiated from the two light-emitting diodes 22 overlap each other.

<Arrangement Examples of Light-Emitting Diodes and TOF Sensor(s)>

Arrangement examples of the light-emitting diodes and the TOF sensor(s) in a closed place such as an inside of a vehicle will be described with reference to FIGS. 19 to 24.

For example, traditionally, for measuring a distance inside a closed space such as a cabin of a vehicle and a habitable room with a person, baggage, or the like being a target, it is necessary to sense a relatively wide viewing angle at a time. However, with a distance measurement sensor using active light sources as in the TOF system or the like, the active light sources are diffused with respect to a wide viewing angle of 100 degrees or more, for example. As a result, the power of the light sources which is radiated to a target object becomes insufficient. Noise relatively increases. Thus, it is difficult to obtain desired distance measurement performance.

Thus, it is desirable to provide a distance measurement apparatus in which further optimization is achieved in such a manner that the light-emitting diodes and the TOF sensors are arranged such that more desirable distance measurement performance can be obtained inside such a closed space.

FIG. 19 shows a first arrangement example of the light-emitting diodes and the TOF sensor(s).

In the first arrangement example of the light-emitting diodes and the TOF sensor(s), a plurality of light-emitting diodes 103 and a plurality of TOF sensors 102 are arranged so as to each divide a sensing range.

That is, as shown in FIG. 19, a distance measurement apparatus 101 installed in a vehicle 100 includes two TOF sensors 102-1 and 102-2 and two light-emitting diodes 103-1 and 103-2. The two TOF sensors 102-1 and 102-2 and the two light-emitting diodes 103-1 and 103-2 are arranged inside a windshield of the vehicle 100. Note that, besides the TOF sensors 102-1 and 102-2 and the light-emitting diodes 103-1 and 103-2, the distance measurement apparatus 101 includes the respective blocks of the distance measurement apparatus 11 of FIG. 1, for example, and illustrations of these blocks are omitted.

As in the TOF sensor 25 of FIG. 1, the TOF sensors 102-1 and 102-2 each receive light from an imaging range. Here, the imaging range is an inside of the closed space of the vehicle 100. At this time, the angle of view of the imaging range that forms images on sensor surfaces of the TOF sensors 102-1 and 102-2 is set to 50 degrees through the light receiver lens 24 of FIG. 1.

As in the light-emitting diode 22 of FIG. 1, the light-emitting diodes 103-1 and 103-2 radiates infrared light beams, each of which is modulated, into the inside of the closed space of the vehicle 100. At this time, the irradiation angle of the infrared light radiated from the light-emitting diodes 103-1 and 103-2 is set to 50 degrees through the light transmitter lens 23 of FIG. 1.

Further, the arrangement is performed such that an imaging range of the TOF sensor 102-1 and an irradiation range of the light-emitting diode 103-1 overlap each other in an approximately identical manner and an imaging range of the TOF sensor 102-2 and an irradiation range of the light-emitting diode 103-2 overlap each other in an approximately identical manner.

Then, in the first arrangement example, the sensing range formed by the TOF sensor 102-1 and the light-emitting diode 103-1 and the sensing range formed by the TOF sensor 102-2 and the light-emitting diode 103-2 are divided on left- and right-hand sides. For example, the arrangement is performed such that, as shown in the figure, the TOF sensor 102-1 and the light-emitting diode 103-1 use the left half of the inside of the vehicle 100 as the sensing range and the TOF sensor 102-2 and the light-emitting diode 103-2 use the right half of the inside of the vehicle 100 as the sensing range.

By dividing the sensing range in this manner, the distance measurement apparatus 101 is capable of suppressing lowering of the distance measurement accuracy in comparison with, for example, a configuration in which a wide range of the right- and left-hand sides of the vehicle 100 is sensed by the pair of the light-emitting diode 103 and the TOF sensor 102.

FIG. 20 shows a second arrangement example of the light-emitting diodes and the TOF sensor(s).

In the second arrangement example of the light-emitting diodes and the TOF sensor(s), the arrangement is performed such that the irradiation range is divided by a plurality of light-emitting diodes 103 and reflection light from these irradiation ranges is received by a single TOF sensor 102.

That is, as shown in FIG. 20, the distance measurement apparatus 101 installed in the vehicle 100 includes a TOF sensor 102 and two light-emitting diodes 103-1 and 103-2. The TOF sensor 102 and the two light-emitting diodes 103-1 and 103-2 are arranged in the inside of the windshield of the vehicle 100. The light-emitting diodes 103-1 and 103-2 are arranged in the vicinity of the TOF sensor 102. Note that, besides the TOF sensor 102 and the light-emitting diodes 103-1 and 103-2, the distance measurement apparatus 101 includes the respective blocks of the distance measurement apparatus 11 of FIG. 1, for example, and illustrations of these blocks are omitted.

As shown in the figure, the irradiation angle of the infrared light of the light-emitting diode 103-1 is set to 100 degrees, for example, and the irradiation angle of the infrared light of the light-emitting diode 103-2 is set to 50 degrees, for example. In this manner, the irradiation range is divided by each of the light-emitting diode 103-1 that radiates the infrared light at a short distance in a wide range and the light-emitting diode 103-2 that radiates the infrared light at a long distance in a narrow range. Then, the TOF sensor 102 is arranged so as to be capable of receiving reflection light from these both irradiation ranges.

By dividing the irradiation range of the infrared light in this manner, the distance measurement apparatus 101 is capable of suppressing lowering of the distance measurement accuracy in comparison with, for example, a configuration in which an area from a short distance to a long distance of the vehicle 100 is sensed by the pair of the light-emitting diode 103 and the TOF sensor 102.

FIG. 21 shows a third arrangement example of the light-emitting diodes and the TOF sensor(s).

In the third arrangement example of the light-emitting diodes and the TOF sensor(s), the arrangement is performed such that the irradiation range is divided by a plurality of light-emitting diodes 103 and reflection light from their irradiation ranges is received by a single TOF sensor 102 in the vicinity of target objects each set as a measurement target.

For example, if, like a vehicle, the positions of occupants to be target objects, for example, a driver's seat, a passenger seat, and a back seat, can be determined in advance, the light-emitting diode 103-1 can be arranged in the vicinity of the occupants on the driver's seat and the passenger seat and the light-emitting diode 103-2 can be arranged in the vicinity of the back seat. Thus, in this case, the light-emitting diode 103-2 is arranged closer to the occupant (target object) on the back seat than the TOF sensor 102 arranged inside the windshield. Then, the TOF sensor 102 is arranged so as to be capable of receiving reflection light from these both irradiation ranges.

By dividing the irradiation range of the infrared light and arranging each of them in the vicinity of its target object in this manner, the distance measurement apparatus 101 is capable of suppressing lowering of the distance measurement accuracy in comparison with, for example, a configuration in which an area from a short distance to a long distance of the vehicle 100 is sensed by the pair of the light-emitting diode 103 and the TOF sensor 102.

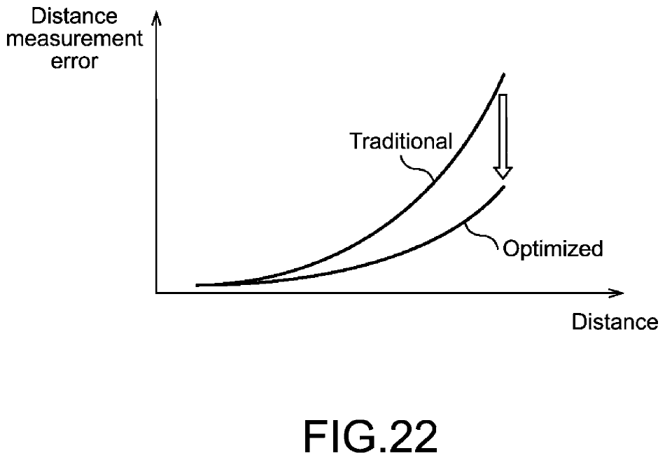

By optimizing the arrangement of the light-emitting diodes and the TOF sensor(s) as described with reference to FIGS. 19 to 21, it is possible to reduce the distance measurement error even if the distance between the TOF sensor 102 and the imaged object is long as compared to the traditional one as shown in FIG. 22.

<Arrangement Example to Arrange Light-Emitting Diodes in Vicinity of Target Objects>

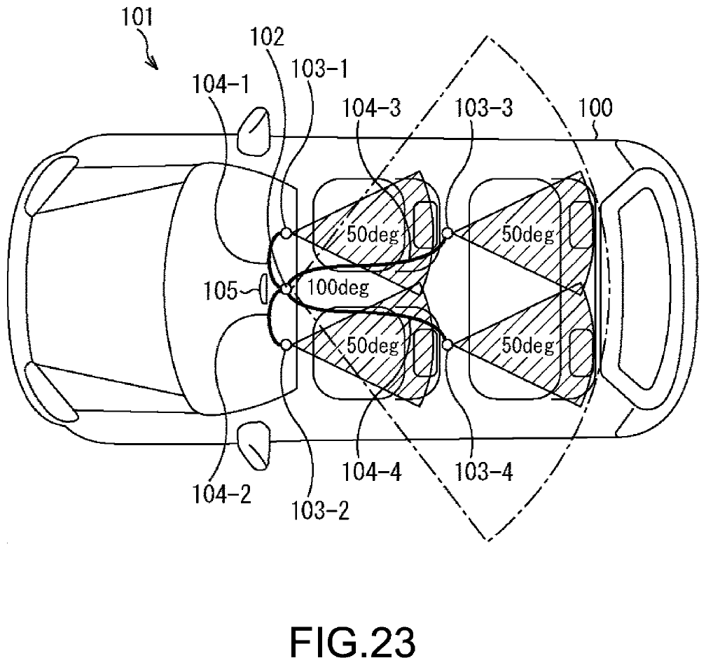

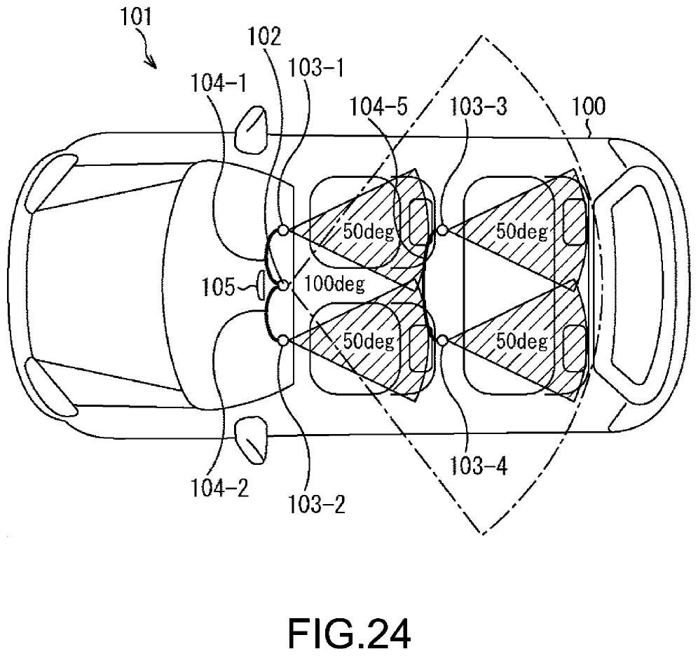

A fourth arrangement example to arrange each of a plurality of light-emitting diodes 103 in the vicinity of a target object with respect to a single TOF sensor 102 will be described with reference to FIGS. 23 and 24.

For example, if the position at which occupants sit can be determined on the basis of seats installed in the vehicle within a closed narrow space like the vehicle 100, it is favorable to place a light-emitting diode 103 in the vicinity of each seat so as to radiate infrared light to the position at which the occupant sits.

In the fourth arrangement example shown in FIG. 23, the TOF sensor 102 is arranged at a portion which is in the vicinity of a rear-view mirror 105 arranged approximately at a center of the windshield within the inside of the vehicle 100 and at which the TOF sensor 102 can take a general view of the inside of the vehicle 100 (e.g., directly below the rear-view mirror 105). Then, four light-emitting diodes 103-1 to 103-4 are arranged so as to radiate infrared light to the seat from the vicinity of the seat on which each occupant sits, which is the front of the corresponding seat.

That is, the light-emitting diode 103-1 is installed in the vicinity of the driver's seat so as to radiate infrared light only to a range necessary for detecting motions of the occupant who sits on the driver's seat. Further, the light-emitting diode 103-2 is installed in the vicinity of the passenger seat so as to radiate infrared light only to a range necessary for detecting motions of the occupant who sits on the passenger seat. Similarly, the light-emitting diodes 103-3 and 103-4 are respectively installed in the left right vicinities of each back seat so as to radiate infrared light only to a range necessary for detecting motions of the occupants who sit on the passenger seats.

By dividing the irradiation range of the infrared light for each position of the occupant that is the target object and arranging each of the light-emitting diodes 103-1 to 103-4 in the vicinity of the target object in this manner, it becomes possible to reduce the amount of light of the infrared light radiated by the light-emitting diodes 103-1 to 103-4. That is, in the fourth arrangement example, each of the light-emitting diodes 103-1 to 103-4 radiates infrared light only to a narrow range in which the occupant sits from the vicinity of the occupant. Therefore, even if the amount of light of the infrared light is reduced, reflection light components thereof can be sufficiently detected at the TOF sensor 102.

Thus, if the distance measurement apparatus 101 employs the fourth arrangement example, the distance measurement apparatus 101 is capable of reducing the power consumption of the light-emitting diodes 103-1 to 103-4 as a whole as compared to a configuration in which the single light-emitting diode 103 is arranged in the vicinity of the TOF sensor 102. Specifically, by utilizing reflection light from the light-emitting diode 103 arranged in the vicinity of the occupant rather than causing infrared light from the light-emitting diode 103 arranged in the vicinity of the TOF sensor 102 to travel back and forth, the power consumption can be reduced to ¼. Along with this, the distance measurement apparatus 101 is capable of reducing heat generation of the light-emitting diodes 103-1 to 103-4, for example.

Further, in the fourth arrangement example, the distance measurement apparatus 101 can be configured to supply each of the light-emitting diodes 103-1 to 103-4 with electric power sequentially in a time division manner and the TOF sensor 102 can be configured to sequentially detect reflection light for each sensing range in which infrared light is radiated by each of the light-emitting diodes 103-1 to 103-4. Thus, the computer for vehicle control 34 is capable of sequentially detecting the gesture of the occupant for each of the sensing ranges.

Then, the distance measurement apparatus 101 is intermittently operated with saved power until the occurrence of an event in any of the sensing ranges (e.g., start of a motion of a gesture made by the occupant) is detected. When the occurrence of an event in a certain sensing range is detected, the distance measurement apparatus 101 preferentially supplies electric power to the light-emitting diode 103 that radiates infrared light to that sensing range. Then, the distance measurement apparatus 101 is capable of performing adaptive operations, for example, detecting events (gestures) in that sensing range in a concentrated manner.

By the way, for generating the depth image from the raw signal output by the TOF sensor 102, it is necessary to synchronize the TOF sensor 102 with the light-emitting diodes 103-1 to 103-4. Therefore, in a configuration in which the light-emitting diodes 103-1 to 103-4 are arranged apart from the TOF sensor 102, it is necessary to connect the TOF sensor 102 to the light-emitting diodes 103-1 to 103-4 through wires 104-1 to 104-4.

Specifically, in the example shown in FIG. 23, the TOF sensor 102 and the light-emitting diode 103-1 are connected to each other through the wire 104-1 and the TOF sensor 102 and the light-emitting diode 103-2 are connected to each other through the wire 104-2. Similarly, the TOF sensor 102 and the light-emitting diode 103-3 are connected to each other through the wire 104-3 and the TOF sensor 102 and the light-emitting diode 103-4 are connected to each other through the wire 104-4.

By arranging the wires 104-1 to 104-4 in the inside of the vehicle 100 in this manner, connecting the TOF sensor 102 to the light-emitting diodes 103-1 to 103-4, and utilizing a common synchronization signal, the TOF sensor 102 can be synchronized with each of the light-emitting diodes 103-1 to 103-4. With this, the depth image can be generated by extracting only reflection light components corresponding to infrared light modulated and radiated by the light-emitting diodes 103-1 to 103-4 from the raw signal output by the TOF sensor 102.

By the way, the wires 104-1 and 104-2 for connecting the TOF sensor 102 to the light-emitting diodes 103-1 and 103-2, which are installed on the front side of the vehicle 100, can be easily handled. In contrast, it is conceivable that it is sometimes difficult to handle the wires 104-3 and 104-4 for connecting the TOF sensor 102, which is installed on the front side of the vehicle 100, to the light-emitting diodes 103-3 and 103-4, which are installed on the rear side of the vehicle 100.

In view of this, implementation of the distance measurement apparatus 101 can be facilitated without connecting the TOF sensor 102 installed on the front side of the vehicle 100 to the light-emitting diodes 103-3 and 103-4 installed on the rear side of the vehicle 100, for example.

For example, in a modified example of the fourth arrangement example which is shown in FIG. 24, the TOF sensor 102 and the light-emitting diodes 103-1 and 103-2, which are installed on the front side of the vehicle 100, are connected to one another through the wires 104-1 and 104-2, respectively. In contrast, in this configuration, the light-emitting diodes 103-3 and 103-4 which are installed on the rear side of the vehicle 100 are connected to each other through a wire 104-5 while the light-emitting diodes 103-3 and 103-4 are not connected to the TOF sensor 102 with a wire.

Even with the configuration in which the TOF sensor 102 and each of the light-emitting diodes 103-3 and 103-4 are arranged apart from each other and are not connected to each other in this manner, if a distance between the TOF sensor 102 and either one of the light-emitting diodes 103-3 and 103-4 is known, the depth image based on the raw signal output from the TOF sensor 102 can be generated by detecting a phase difference of reflection light beams of infrared light beams radiated from the light-emitting diodes 103-3 and 103-4 in a synchronized manner. Note that the details of processing to generate the depth image in such a configuration have been disclosed in Japanese Patent Application No. 2016-162320 filed by the applicants of this application.

Note that other various methods can be employed as a method of acquiring the depth image in the configuration in which the TOF sensor 102 and the light-emitting diode 103 are arranged apart from each other and are not connected to each other through the wires 104.

By improving the degree of freedom of arrangement of the light-emitting diodes 103 with respect to the TOF sensor 102 in this manner, it is possible to arrange the light-emitting diodes 103 closer to the target object, and to reduce the power consumption of the light-emitting diodes 103.

Here, in the signal processor 27 (FIG. 1) of the distance measurement apparatus 101, the computer for vehicle control 34 executes the application to detect the gesture based on the hand motion of the occupant by utilizing the depth image, as described above. An instruction signal associated with the detected gesture, for example, is output as the application processing signal. Specifically, the computer for vehicle control 34 is capable of recognizing a gesture for performing various operations (reproduction, stop, on/off, etc.) on in-vehicle devices such as an audio device, an air conditioner, and lights installed in the vehicle 100. Further, the computer for vehicle control 34 is, for example, capable of recognizing a gesture for performing input of various tasks on an agent function of responding to tasks of a user by utilizing artificial intelligence (AI), without interrupting conversation between the occupants.

The computer for vehicle control 34 recognizes the gesture of the occupant in this manner. Thus, it is possible for a driver who needs to look the forward roadway to give instructions regarding operations on the in-vehicle devices without looking away in comparison with a case where the driver makes various operations with operation switches, for example. That is, the driver has to look away from the forward roadway for viewing the operation switches in the case of utilizing the operation switches while the driver can make operations without looking away in the case of utilizing gestures unlike the former case.

By the way, the closed place like the vehicle 100 has been described in the above-mentioned arrangement examples of the light-emitting diodes and the TOF sensor(s). However, the distance measurement apparatus 11 can be applied to those other than the vehicle 100. That is, the distance measurement apparatus 11 can be utilized for performing gesture recognition in a particular closed place, for example, a place where user's position is limited to a narrow range.

For example, with the distance measurement apparatus 11, a user who is watching a sport event on a television in a particular place such as a couch in a living room can made various operations by gestures without moving the eyesight from the screen, that is, without losing concentration on the screen. Further, with the distance measurement apparatus 11, a user who is, for example, cooking in a kitchen and cannot operate a device with hands which are not clean due to such work, for example, can made various operations by gestures without touching the device with such hands. Similarly, with the distance measurement apparatus 11, the user who is, for example, performing a detailed task such as assembling in a predetermined working place and cannot operate a device with hands can made various operations by gestures without touching the device with hands.

By the way, the distance measurement apparatus 11 is configured to acquire the depth image by utilizing the TOF sensor 25. Thus, the distance measurement apparatus 11 is superior to a configuration utilizing a stereo camera that determines a distance by utilizing a plurality of cameras, for example. That is, the stereo camera is inferior to the TOF sensor 25 because it is difficult to distinguish imaged objects from one another, which have similar color or reflectance and are located at different distances, arithmetic operation resource and power consumption increase due to its large arithmetic operation amount, and so on. Further, the configuration utilizing the TOF sensor 25 is superior to a configuration utilizing structured light for projecting a specially designed light pattern onto a surface of an object and analyzing deformation of the projected pattern in that the configuration utilizing the TOF sensor 25 can reduce the arithmetic operation amount.

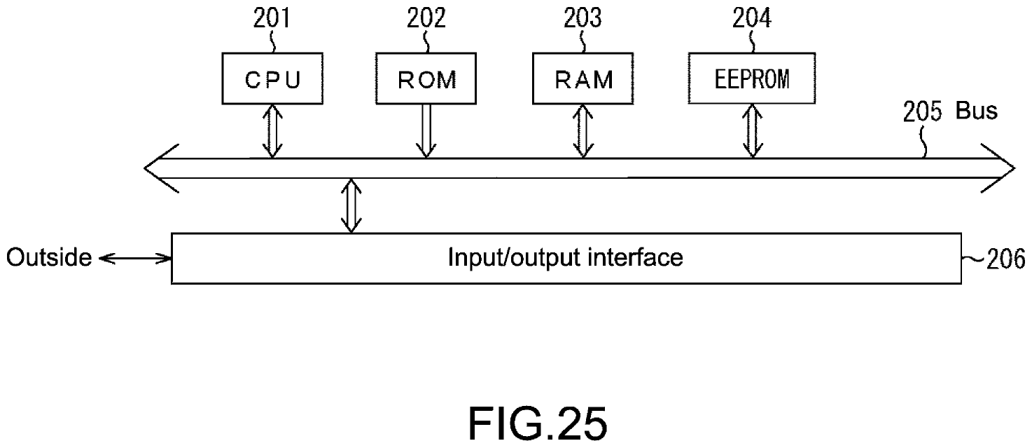

FIG. 25 is a block diagram showing a configuration example of hardware of a computer that executes the above-mentioned series of processing in accordance with a program.

In the computer, a central processing unit (CPU) 201, a read only memory (ROM) 202, a random access memory (RAM) 203, and an electronically erasable and programmable read only memory (EEPROM) 204 are connected to one another through a bus 205. An input/output interface 206 is further connected to the bus 205. The input/output interface 206 is connected to the outside.

In the computer configured in the above-mentioned manner, the CPU 201 loads programs stored in the ROM 202 and the EEPROM 204, for example, via the bus 205 into the RAM 203 and executes the loaded programs. In this manner, the above-mentioned series of processing is performed. Further, the programs executed by the computer (CPU 201) may be written in the ROM 202 in advance or may be installed into the EEPROM 204 from the outside via the input/output interface 206 and updated, for example.

In so far as the embodiments of the invention described above are implemented, at least in part, using software-controlled data processing apparatus, it will be appreciated that a computer program providing such software control and a transmission, storage or other medium by which such a computer program is provided are envisaged as aspects of the present invention.

<Combination Examples of Configurations>

Note that the present technology can also take the following configurations.

(1)

A distance measurement system for a vehicle, the system comprising:

a plurality of light sources including a first light source and a second light source, wherein the first light source is configured to irradiate a first irradiation range within the vehicle and the second light source is configured to irradiate a second irradiation range within the vehicle different from the first irradiation range; and

at least one time-of-flight sensor arranged to sense light reflected from objects in the first irradiation range and the second irradiation range.

(2)

The distance measurement system for a vehicle according to (1), wherein the at least one time-of-flight sensor includes a first time-of-flight sensor arranged to sense light reflected from objects in the first irradiation range and a second time-of-flight sensor arranged to sense light reflected from objects in the second irradiation range.

(3)

The distance measurement system for a vehicle according to (2), wherein the first time-of-flight sensor is arranged to receive light from a first imaging range that spatially overlaps the first irradiation range, and wherein the second time-of flight sensor is arranged to receive light from a second imaging range that spatially overlaps the second irradiation range.

(4)

The distance measurement system for a vehicle according to (3), wherein each of the first time-of-flight sensor and the second time-of-flight sensor includes a sensor surface, and wherein an angle of view of each of the first imaging range and the second imaging range that forms images on a respective sensor surface of the first time-of-flight sensor and the second time-of-flight sensor is equal to each other.

(5)

The distance measurement system for a vehicle according to (4), wherein the angle of view of each of the first imaging range and the second imaging range is the same.

(6)

The distance measurement system for a vehicle according to (5), wherein the angle of view of each of the first imaging range and the second imaging range is approximately 50 degrees.

(7)

The distance measurement system for a vehicle according to anyone of (1) to (6), wherein the at least one time-of-flight sensor and the plurality of light sources are configured to be arranged on windshield of the vehicle.

(8)

The distance measurement system for a vehicle according to anyone of (1) to (7), further comprising:

a signal processor configured to:

process signals detected by the at least one time-of-flight sensor to determine a first distance to at least one object in the first irradiation range and/or the second irradiation range; and

output at least one control signal based, at least in part, on the first distance and/or the second distance.

(9)

The distance measurement system for a vehicle according to anyone of (1) to (8), wherein each of first light source and the second light source comprise light emitting diodes.

(10)

The distance measurement system for a vehicle according to anyone of (1) to (9), wherein the at least one time-of-flight sensor comprises a single time-of-flight sensor arranged to sense light reflected from objects in the first irradiation range and the second irradiation range.

(11)

The distance measurement system for a vehicle according to (10), wherein the first light source is configured to irradiate light within the first irradiation range at a first distance from the first light source, wherein the second light source is configured to irradiate light within the second irradiation range at a second distance from the second light source, and wherein the second distance is greater than the first distance.

(12)

The distance measurement system for a vehicle according to (11), wherein an irradiation angle of the first irradiation range and the second irradiation range are different.

(13)

The distance measurement system for a vehicle according to (11), wherein the first light source and the second light source are configured to be arranged on a windshield of the vehicle.

(14)

The distance measurement system for a vehicle according to (10), wherein the first light source is configured to irradiate light within the first irradiation range at a first distance from the first light source, wherein the second light source is configured to irradiate light within the second irradiation range at a second distance from the second light source, and wherein the second distance is equal to the first distance.

(15)

The distance measurement system for a vehicle according to (14), wherein an irradiation angle of the first irradiation range is equal to an irradiation angle of the second irradiation range.

(16)

The distance measurement system for a vehicle according to anyone of (1) to (15), wherein the first irradiation range and the second irradiation range do not overlap.

(17)

The distance measurement system for a vehicle according to (16), wherein the first light source is configured to irradiate light within the first irradiation range at a first distance from the first light source, wherein the second light source is configured to irradiate light within the second irradiation range at a second distance from the first light source, wherein the second distance is larger than the first distance.

(18)

The distance measurement system for a vehicle according to (16), wherein an irradiation angle of the first irradiation range and the second irradiation range are equal to each other.

(19)

The distance measurement system for a vehicle according to anyone of (1) to (18), further comprising a third light source and a fourth light source, wherein the third light source is configured to irradiate a third irradiation range within the vehicle and the fourth light source is configured to irradiate a fourth irradiation range within the vehicle, wherein each of the first irradiation range, the second irradiation range, the third irradiation range and the fourth irradiation range are different.

(20)

The distance measurement system for a vehicle according to (19), wherein the at least one time-of-flight sensor comprises a single sensor arranged to sense light reflected from objects in the first irradiation range, the second irradiation range, the third irradiation range, and the fourth irradiation range.

(21)

The distance measurement system for a vehicle according to (20), wherein the first light source is configured to irradiate light within the first irradiation range at a first distance from the first light source, wherein the second light source is configured to irradiate light within the second irradiation range at a second distance from the second light source, wherein the first distance and the second distance are equal to each other,

wherein the third light source is configured to irradiate light within the third irradiation range at a third distance from the third light source,

wherein the fourth light source is configured to irradiate light within the fourth irradiation range at the fourth distance from the first light source,

wherein the third distance and the second distance are equal to each other, and

wherein the second distance is larger than the first distance.

(22)

The distance measurement system for a vehicle according to (21), further comprising: a first wiring configured to couple the first light source to the single sensor; and a second wiring configured to couple the second light source to the single sensor.

(23)

The distance measurement system for a vehicle according to (22), further comprising: a third wiring configured to couple the third light source to the single sensor; and a fourth wiring configured to couple the fourth light source to the single sensor.

(24)

The distance measurement system for a vehicle according to (22), further comprising a third wiring configured to couple the third light source to the fourth light source.

(25)

A distance measurement apparatus, including:

a light source configured to radiate light to a target object that is a target whose distance is to be measured, the light being modulated;

a sensor configured to receive reflection light that is light radiated from the light source and reflected on the target object;

a signal processor configured to perform signal processing to determine at least a distance to the target object by using a signal output from the sensor;

an error calculator configured to calculate a distance measurement error of a measurement result of measuring the distance to the target object; and a power supply configured to perform feed-back control based on the distance measurement error, convert an output voltage of a battery into a predetermined voltage, and supply the predetermined voltage.

(26)

The distance measurement apparatus according to (25), in which the signal processor is configured to output an application processing signal to a post-stage block and supply the application processing signal to the error calculator, the application processing signal being obtained by executing an application using the distance to the target object, and the error calculator is configured to calculate the distance measurement error on the basis of the application processing signal.

(27)

The distance measurement apparatus according to (25) or (26), in which the signal processor is configured to supply a depth signal to the error calculator, the depth signal indicating the distance to the target object which is determined for each pixel of the sensor, and the error calculator is configured to calculate the distance measurement error on the basis of the depth signal.

(28)

The distance measurement apparatus according to any of (25) to (27), in which the sensor is configured to supply a raw signal to the signal processor and also supply the raw signal to the error calculator, the raw signal including an amount of light received by each pixel as a pixel value, and the error calculator is configured to calculate the distance measurement error on the basis of the raw signal.

(29)

The distance measurement apparatus according to any of (25) to (28), in which the power supply is any one of a power supply for a light source which is configured to supply the light source with electric power, a power supply for a sensor which is configured to supply the sensor with electric power, and a power supply for signal processing which is configured to supply the signal processor with electric power.

(30)

A distance measurement method for a distance measurement apparatus including a light source configured to radiate light to a target object that is a target whose distance is to be measured, the light being modulated, a sensor configured to receive reflection light that is light radiated from the light source and reflected on the target object, and a signal processor configured to perform signal processing to determine at least a distance to the target object by using a signal output from the sensor, the distance measurement method including: calculating a distance measurement error of a measurement result of measuring the distance to the target object; and

performing feed-back control based on the distance measurement error, converting an output voltage of a battery into a predetermined voltage, and supplying the predetermined voltage.

(31)

A program for a distance measurement apparatus including

a light source configured to radiate light to a target object that is a target whose distance is to be measured, the light being modulated,

a sensor configured to receive reflection light that is light radiated from the light source and reflected on the target object, and

a signal processor configured to perform signal processing to determine at least a distance to the target object by using a signal output from the sensor, the program causing a computer to execute processing including steps of:

calculating a distance measurement error of a measurement result of measuring the distance to the target object; and

performing feed-back control based on the distance measurement error, converting an output voltage of a battery into a predetermined voltage, and supplying the predetermined voltage.

(32)

A distance measurement apparatus, including

a light source configured to radiate light to a target object that is a target whose distance is to be measured, the light being modulated;

a sensor configured to receive reflection light that is light radiated from the light source and reflected on the target object; and a control unit configured to control a peak voltage of the light source.

(33)

The distance measurement apparatus according to any of (25) to (32), which is configured to lower a frame rate of the sensor while reducing the peak voltage of the light source.

(34)

The distance measurement apparatus according to any of (25) to (32), in which the control unit is configured to perform control to increase a voltage of electric power supplied into the sensor while reducing the peak voltage of the light source.

(35)

The distance measurement apparatus according to any of (25) to (32), in which the control unit is configured to perform control to perform pixel binning at the sensor while reducing the peak voltage of the light source.

(36)

The distance measurement apparatus according to any of (25) to (32), in which the light source includes a plurality of light sources, and

the control unit is configured to reduce peak voltages of the plurality of light sources.

(37)

The distance measurement apparatus according to (26), which is configured to form an irradiation pattern in such a manner that an amount of light increases at a portion at which irradiation light beams radiated from the plurality of light sources overlap each other.

(38)

A distance measurement method for a distance measurement apparatus including

a light source configured to radiate light to a target object that is a target whose distance is to be measured, the light being modulated, and

a sensor configured to receive reflection light that is light radiated from the light source and reflected on the target object, the distance measurement method including controlling a peak voltage of the light source.

(39)

A program for a distance measurement apparatus including

a light source configured to radiate light to a target object that is a target whose distance is to be measured, the light being modulated, and

a sensor configured to receive reflection light that is light radiated from the light source and reflected on the target object, the program causing a computer to execute processing including a step of controlling a peak voltage of the light source.

(40)

A distance measurement apparatus, including:

a plurality of light sources each configured to radiate light to a target object that is a target whose distance is to be measured, the light being modulated; and

one or more sensors each configured to receive reflection light that is light radiated from each of the plurality of light sources and reflected on the target object, the plurality of light sources and the one or more sensors being arranged in an inside of a space for sensing a predetermined sensing range, the space being closed.

(41)

The distance measurement apparatus according to (40), in which the plurality of light sources and the sensors are arranged in such a manner that

each of the plurality of light sources and each of the sensors are paired and arranged in the vicinity of each other, and

the predetermined sensing range in the inside of the space is divided by the paired light sources and sensors.

(42)

The distance measurement apparatus according to (40), in which

the plurality of light sources and the one sensor are arranged in such a manner that the plurality of light sources are arranged in the vicinity of the one sensor and divide an irradiation range of the light in the inside of the space, and

the one sensor receives reflection light from the divided irradiation ranges.

(43)

The distance measurement apparatus according to (40), in which

the plurality of light sources and the one sensor are arranged in such a manner that the plurality of light sources are each arranged in the vicinity of the target object that is a measurement target thereof and divide an irradiation range of the light in the inside of the space, and

the one sensor receives reflection light from the divided irradiation ranges.

(44)

The distance measurement apparatus according to (43), in which at least one of the plurality of light sources is arranged closer to the target object than the one sensor.

(45)

The distance measurement apparatus according to (43), in which the plurality of light sources are each arranged in the vicinity of the target object, which is a measurement target thereof, with respect to the one sensor, and each configured to radiate the light to the corresponding target object.

(46)

The distance measurement apparatus according to (45), further including

a signal processor configured to perform signal processing to determine a distance to a person who is the target object by using a signal output from the one sensor, in which the signal processor is configured to detect a particular gesture made by the person by utilizing a depth image based on the distance and output an instruction signal associated with the gesture.

(47)

The distance measurement apparatus according to (46), which is configured to supply the plurality of light sources with electric power sequentially in a time division manner, in which the one sensor is configured to sequentially detect reflection light beams from the irradiation ranges of the plurality of light sources, the distance measurement apparatus being further configured to preferentially supply, if the signal processor detects start of a motion of the gesture made by the person in any one of the irradiation ranges, electric power to one of the plurality of light sources, which radiates the light to the one of the irradiation ranges.

(48)

The distance measurement apparatus according to any of (45) to (47), in which the one sensor is arranged in the vicinity of a rear-view mirror arranged approximately at a center of a front of an inside of a vehicle, and the plurality of light sources are each arranged to radiate the light to each of a plurality of seats installed in the vehicle, which is located in the vicinity of the light source.

(49)

The distance measurement apparatus according to any of (45) to (48), in which the one sensor and each of the plurality of light sources arranged apart from the one sensor are connected to each other through a wire and synchronized in accordance with a common synchronization signal supplied through the wire.

(50)

The distance measurement apparatus according to (49), in which the one sensor and each of the plurality of light sources arranged for a seat installed at the front of the inside of the vehicle are connected to each other through a wire, and the plurality of light sources arranged for a seat installed in a place other than the front of the inside of the vehicle are not connected to the one sensor but connected to each other through the wire.

Note that this embodiment is not limited to the above-mentioned embodiments and various changes can be made without departing from scope of the present disclosure. Further, the effects described in the present specification are merely illustrative and not limitative and other effects may be given.

It should be understood by those skilled in the art that various modifications, combinations, sub-combinations and alterations may occur depending on design requirements and other factors insofar as they are within the scope of the appended claims.

### REFERENCE SIGNS LIST

11 Distance measurement apparatus
12 Distance measurement processing unit
13 Power supply unit
14 FPGA
21 Light modulator
22 light-emitting diode
23 Light transmitter lens
24 Light receiver lens
25 TOF sensor
26 Image storage unit
27 Signal processor
31 Unaffected-image generator
32 Arithmetic processor
33 Output unit
34 Computer for vehicle control
41 Main battery
42 Power supply for light source
43 Power supply for TOF sensor
44 Power supply for signal processing
45 Error calculator
100 Vehicle
101 Distance measurement apparatus
102 TOF sensor
103 Light-emitting diode

1. A distance measurement system for a vehicle, the system comprising:
a plurality of light sources including a first light source and a second light source, wherein the first light source is configured to irradiate a first irradiation range within the vehicle and the second light source is configured to irradiate a second irradiation range within the vehicle different from the first irradiation range; and
at least one time-of-flight sensor arranged to sense light reflected from objects in the first irradiation range and the second irradiation range.

2. The distance measurement system for a vehicle according to claim 1, wherein the at least one time-of-flight sensor includes a first time-of-flight sensor arranged to sense light reflected from objects in the first irradiation range and a second time-of-flight sensor arranged to sense light reflected from objects in the second irradiation range.

3. The distance measurement system for a vehicle according to claim 2,
wherein the first time-of-flight sensor is arranged to receive light from a first imaging range that spatially overlaps the first irradiation range, and
wherein the second time-of flight sensor is arranged to receive light from a second imaging range that spatially overlaps the second irradiation range.

4. The distance measurement system for a vehicle according to claim 3, wherein each of the first time-of-flight sensor and the second time-of-flight sensor includes a sensor surface, and wherein an angle of view of each of the first imaging range and the second imaging range that forms images on a respective sensor surface of the first time-of-flight sensor and the second time-of-flight sensor is equal to each other.

5. The distance measurement system for a vehicle according to claim 4, wherein the angle of view of each of the first imaging range and the second imaging range is the same.

6. The distance measurement system for a vehicle according to claim 5, wherein the angle of view of each of the first imaging range and the second imaging range is 50 degrees.

7. The distance measurement system for a vehicle according to claim 1, wherein the at least one time-of-flight sensor and the plurality of light sources are configured to be arranged on a windshield of the vehicle.

8. The distance measurement system for a vehicle according to claim 1, further comprising:
a signal processor configured to:
process signals detected by the at least one time-of-flight sensor to determine a first distance to at least one object in the first irradiation range and/or the second irradiation range; and
output a control signal based, at least in part, on the first distance and/or the second distance.

9. The distance measurement system for a vehicle according to claim 1, wherein each of the first light source and the second light source comprises at least one light emitting diode.

10. The distance measurement system for a vehicle according to claim 1, wherein the at least one time-of-flight sensor comprises a single time-of-flight sensor arranged to sense light reflected from objects in the first irradiation range and the second irradiation range.

11. The distance measurement system for a vehicle according to claim 10,
wherein the first light source is configured to irradiate light within the first irradiation range at a first distance from the first light source,
wherein the second light source is configured to irradiate light within the second irradiation range at a second distance from the second light source, and
wherein the second distance is greater than the first distance.

12. The distance measurement system for a vehicle according to claim 11, wherein an irradiation angle of the first irradiation range and the second irradiation range are different.

13. The distance measurement system for a vehicle according to claim 11, wherein the first light source and the second light source are configured to be arranged on a windshield of the vehicle.

14. The distance measurement system for a vehicle according to claim 10,
wherein the first light source is configured to irradiate light within the first irradiation range at a first distance from the first light source,
wherein the second light source is configured to irradiate light within the second irradiation range at a second distance from the second light source, and
wherein the second distance is equal to the first distance.

15. The distance measurement system for a vehicle according to claim 14, wherein an irradiation angle of the first irradiation range is equal to an irradiation angle of the second irradiation range.

16. The distance measurement system for a vehicle according to claim 1, wherein the first irradiation range and the second irradiation range do not overlap.

17. The distance measurement system for a vehicle according to claim 16,
wherein the first light source is configured to irradiate light within the first irradiation range at a first distance from the first light source,
wherein the second light source is configured to irradiate light within the second irradiation range at a second distance from the first light source,
wherein the second distance is larger than the first distance.

18. The distance measurement system for a vehicle according to claim 16, wherein an irradiation angle of the first irradiation range and the second irradiation range are equal to each other.

19. The distance measurement system for a vehicle according to claim 1, further comprising a third light source and a fourth light source,
wherein the third light source is configured to irradiate a third irradiation range within the vehicle and the fourth light source is configured to irradiate a fourth irradiation range within the vehicle,
wherein each of the first irradiation range, the second irradiation range, the third irradiation range and the fourth irradiation range are different.

20. The distance measurement system for a vehicle according to claim 19, wherein the at least one time-of-flight sensor comprises a single sensor arranged to sense light reflected from objects in the first irradiation range, the second irradiation range, the third irradiation range, and the fourth irradiation range.

21. The distance measurement system for a vehicle according to claim 20,
wherein the first light source is configured to irradiate light within the first irradiation range at a first distance from the first light source,
wherein the second light source is configured to irradiate light within the second irradiation range at a second distance from the second light source, wherein the first distance and the second distance are equal to each other,
wherein the third light source is configured to irradiate light within the third irradiation range at a third distance from the third light source,
wherein the fourth light source is configured to irradiate light within the fourth irradiation range at the fourth distance from the first light source, wherein the third distance and the second distance are equal to each other, and
wherein the second distance is larger than the first distance.

22. The distance measurement system for a vehicle according to claim 21, further comprising:
a first wiring configured to couple the first light source to the single sensor; and
a second wiring configured to couple the second light source to the single sensor.

23. The distance measurement system for a vehicle according to claim 22, further comprising:
a third wiring configured to couple the third light source to the single sensor; and
a fourth wiring configured to couple the fourth light source to the single sensor.

24. The distance measurement system for a vehicle according to claim 22, further comprising a third wiring configured to couple the third light source to the fourth light source.
